(19) United States
(12) Patent Application Publication
(10) Pub. No.: US 2025/0298248 A1
(43) Pub. Date: Sep. 25, 2025

(54) COMPACT WAVEGUIDE DISPLAY SYSTEM INCLUDING ZONAL ILLUMINATED NON-EMISSIVE DISPLAY

(71) Applicant: Meta Platforms Technologies, LLC, Menlo Park, CA (US)

(72) Inventors: Derek WALLIN, Monroe, WA (US); Robert UPTON, Del Mar, CA (US)

(21) Appl. No.: 19/082,125

(22) Filed: Mar. 17, 2025

Related U.S. Application Data
(60) Provisional application No. 63/567,838, filed on Mar. 20, 2024.

(51) Int. Cl. G02B 27/01; G02B 27/28

(52) U.S. Cl. CPC G02B 27/0172; G02B 27/283

(57) ABSTRACT

A system is provided. The system includes a display panel and an imaging assembly including a plurality of optical elements configured to guide a backlight to illuminate the display panel. The system also includes a waveguide including a reflective polarizer and disposed between the plurality of optical elements included in the imaging assembly. The display panel is configured to modulate the backlight into an image light representing a virtual image. The imaging assembly is configured to guide the image light toward the reflective polarizer. The reflective polarizer is configured to couple the image light into the waveguide.

### CROSS REFERENCE TO RELATED APPLICATION

This application claims the benefit of priority to U.S. Provisional Application No. 63/567,838, filed on Mar. 20, 2024. The content of the above-referenced application is incorporated by reference in its entirety.

### TECHNICAL FIELD

The present disclosure relates generally to optical systems and, more specifically, to an illumination system including zonal illumination optical concentrators.

### BACKGROUND

An artificial reality system, such as a head-mounted display (“HMD”) or heads-up display (“HUD”) system, generally includes a near-eye display (“NED”) system in the form of a headset or a pair of glasses, which is configured to present content to a user via an electronic or optic display within a distance, for example, of about 10-20 mm in front of the eyes of a user. The NED system may display virtual objects or combine images of real objects with virtual objects, as in augmented reality (“AR”), virtual reality (“VR”), and/or mixed reality (“MR”) applications. VR, AR, and MR head-mounted displays have wide applications in various fields, including engineering design, medical surgery practice, and video gaming. For example, a user can wear a VR head-mounted display integrated with audio headphones while playing video games so that the user can have an interactive experience in an immersive virtual environment.

### SUMMARY OF THE DISCLOSURE

One aspect of the present disclosure provides a system including a display panel and an imaging assembly including a plurality of optical elements configured to guide a backlight to illuminate the display panel. The system also includes a waveguide including a reflective polarizer and disposed between the plurality of optical elements included in the imaging assembly. The display panel is configured to modulate the backlight into an image light representing a virtual image. The imaging assembly is configured to guide the image light toward the reflective polarizer. The reflective polarizer is configured to couple the image light into the waveguide.

Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The following drawings are provided for illustrative purposes according to various disclosed embodiments and are not intended to limit the scope of the present disclosure. In the drawings:

FIG. 1A illustrates a schematic diagram of an artificial reality system, according to an example of the present disclosure;

FIG. 1B illustrates a schematic cross-sectional view of the artificial reality system shown in FIG. 1A, according to an example of the present disclosure;

FIG. 2A illustrates a schematic diagram of a waveguide display system, according to an example of the present disclosure;

FIG. 2B illustrates a schematic diagram of a light source array that may be included in the waveguide display system shown in FIG. 2A, according to an example of the present disclosure;

FIG. 2C illustrates a schematic diagram of a concentrator array and an illumination unit that may be included in the waveguide display system shown in FIG. 2A, according to an example of the present disclosure;

FIG. 2D illustrates a schematic diagram of an illumination unit and a concentrator that may be included in the waveguide display system shown in FIG. 2A, according to an example of the present disclosure;

FIG. 3A illustrates a schematic diagram of a waveguide display system, according to an example of the present disclosure;

FIG. 3B illustrates a schematic diagram of a waveguide display system, according to an example of the present disclosure;

FIG. 4A illustrates a schematic diagram of a waveguide display system, according to an example of the present disclosure;

FIG. 4B illustrates a light propagation path throughout the waveguide display system shown in FIG. 4A, according to an example of the present disclosure;

FIG. 5A illustrates a schematic diagram of a waveguide display system, according to an example of the present disclosure;

FIG. 5B illustrates a light propagation path throughout the waveguide display system shown in FIG. 5A, according to an example of the present disclosure;

FIG. 5C illustrates a light propagation path in a polarization recycling assembly that may be included in the waveguide display system shown in FIG. 5A, according to an example of the present disclosure;

FIG. 6A illustrates a schematic diagram of a waveguide display system, according to an example of the present disclosure;

FIG. 6B illustrates a schematic diagram of a waveguide display system, according to an example of the present disclosure;

FIG. 7A illustrates a schematic diagram of a waveguide display system, according to an example of the present disclosure; and

FIG. 7B illustrates a schematic diagram of a waveguide display system, according to an example of the present disclosure.

### DETAILED DESCRIPTION

Various aspects of the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or a combination thereof. An “optical coupling” between two optical devices refers to a configuration in which the two optical devices are arranged in an optical series, and a light output from one optical device may be directly or indirectly received by the other optical device. An optical series refers to optical positioning of a plurality of optical devices in a light path, such that a light output from one optical device may be transmitted, reflected, diffracted, converted, modified, or otherwise processed or manipulated by one or more of other optical devices. The sequence in which the plurality of optical devices are arranged may or may not affect an overall output of the plurality of optical devices. A coupling may be a direct coupling or an indirect coupling (e.g., coupling through an intermediate element).

The phrase “one or more” may be interpreted as “at least one.” The phrase “at least one of A or B” may encompass various combinations of A and B, such as A only, B only, or A and B. Likewise, the phrase “at least one of A, B, or C” may encompass various combinations of A, B, and C, such as A only, B only, C only, A and B, A and C, B and C, or A and B and C. The phrase “A and/or B” has a meaning similar to that of the phrase “at least one of A or B.” For example, the phrase “A and/or B” may encompass various combinations of A and B, such as A only, B only, or A and B. Likewise, the phrase “A, B, and/or C” has a meaning similar to that of the phrase “at least one of A, B, or C.” For example, the phrase “A, B, and/or C” may encompass various combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The wavelength ranges, spectra, or bands mentioned in the present disclosure are for illustrative purposes. The disclosed optical device, system, element, assembly, and method may be applied to a visible wavelength range, as well as other wavelength ranges, such as an ultraviolet (“UV”) wavelength range, an infrared (“IR”) wavelength range, or a combination thereof.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable. The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The present discourse provides a compact waveguide display system (or assembly) having a reduced complexity, a reduced form factor, and a reduced weight. The compact waveguide display system disclosed herein may provide an illumination control and a capability to integrate efficiency schemes, such as zonal illumination, polarization recovery (or polarization recycling), etc. The compact waveguide display systems disclosed herein may also provide a capability to integrate another optical function, such as an eye tracking and/or a face tracking function, into the same waveguide as the display channel while maintaining a low-profile hardware configuration.

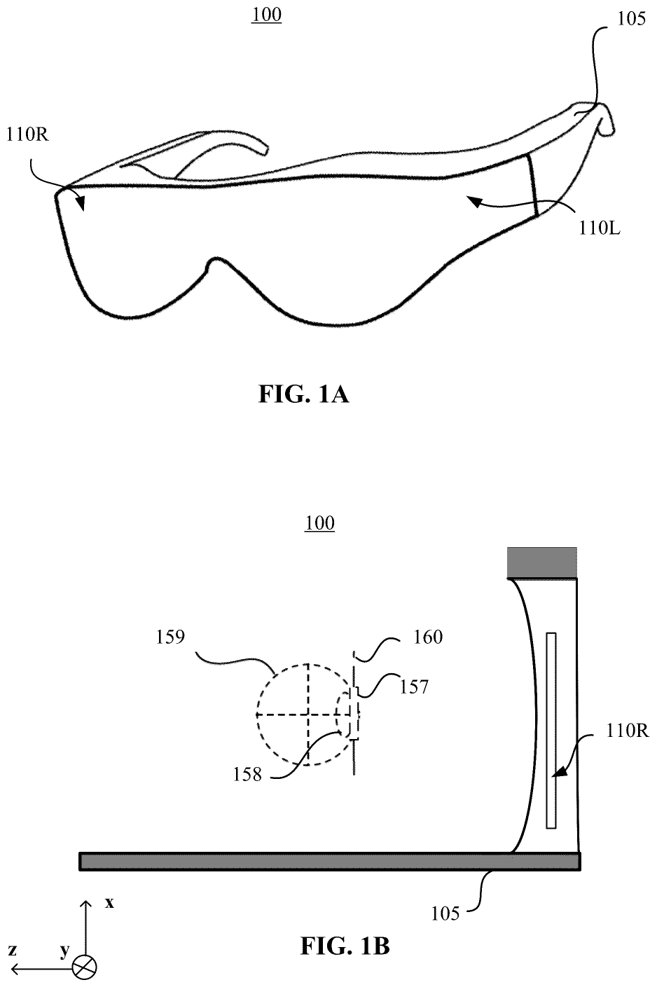

FIG. 1A illustrates a schematic diagram of an artificial reality system 100, according to an example of the present disclosure. The artificial reality system 100 may present virtual reality, augmented reality, and/or mixed reality content to a user, such as images, videos, audios, or a combination thereof. In some examples, the artificial reality system 100 may be configured to be worn on a head of a user (e.g., by having the form of spectacles or eyeglasses, as shown in FIG. 1A), or to be included as a part of a helmet that is worn by the user. In some examples, the artificial reality system 100 may be referred to as a head-mounted display. In some examples, the artificial reality system 100 may be configured for placement in proximity of an eye or eyes of the user at a fixed location in front of the eye(s), without being mounted to the head of the user. For example, the artificial reality system 100 may be mounted in a vehicle, such as a car or an airplane, at a location in front of an eye or eyes of the user.

For discussion purposes, FIG. 1A shows that the artificial reality system 100 includes a frame 105 configured to mount to a head of a user, and left-eye and right-eye display systems 110L and 110R mounted to the frame 105. The frame 105 is merely an example structure to which various components of the artificial reality system 100 may be mounted. Other suitable types of fixtures may be used in place of or in combination with the frame 105. The left-eye and right-eye display systems 110L and 110R may be customized to a variety of shapes and sizes to conform to different styles of the frame 105.

FIG. 1B is a cross-sectional view of half of the artificial reality system 100 shown in FIG. 1A according to an example of the present disclosure. For illustrative purposes, FIG. 1B shows the cross-sectional view associated with the right-eye display system 110R. The left-eye display system 110L may include the same or similar structure and components. Referring to FIG. 1B, the right-eye display system 110R may include a waveguide display assembly, which may be any one of the waveguide display assemblies disclosed herein. The waveguide display assembly may include a light source assembly (e.g., a projector), and a waveguide coupled with an in-coupling element and an out-coupling element. The light source assembly may be configured to generate and output an image light (e.g., a visible light representing a virtual image) propagating toward the in-coupling element. The waveguide coupled with the in-coupling element and the out-coupling element may be configured to guide the image light toward an eye-box region 160 of the artificial reality system 100. The eye-box region 160 is a region in space where an eye pupil 158 of an eye 159 of the user may be positioned to perceive the virtual image generated by the light source assembly. The eye-box region 160 may include one or more exit pupils 157. The exit pupil 157 may be a location where the eye pupil 158 is positioned in the eye-box region 160. In some examples, the light source assembly may be a zonal illuminated projector, which incorporates dynamic zonal brightness control and spectral mixing control of the light source wavelengths, thereby enhancing the display performance, power budget, and chromatic content. In some examples, the artificial reality system 100 may also include an object tracking system (or assembly), such as an eye and/or face tracking system, which may be integrated with the waveguide display assembly.

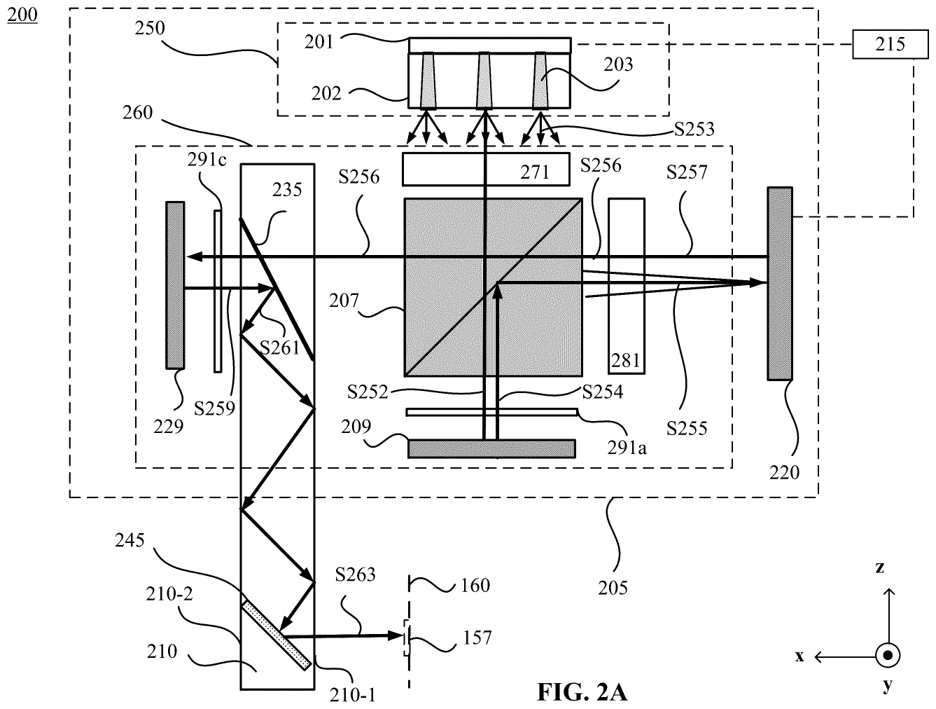

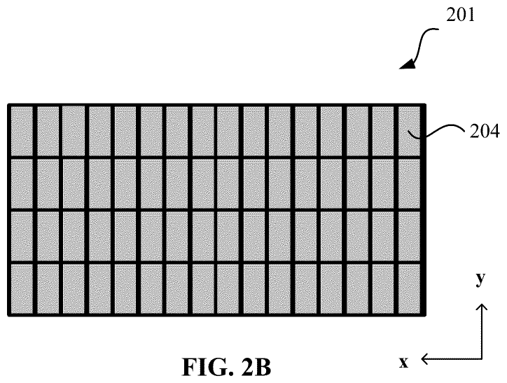

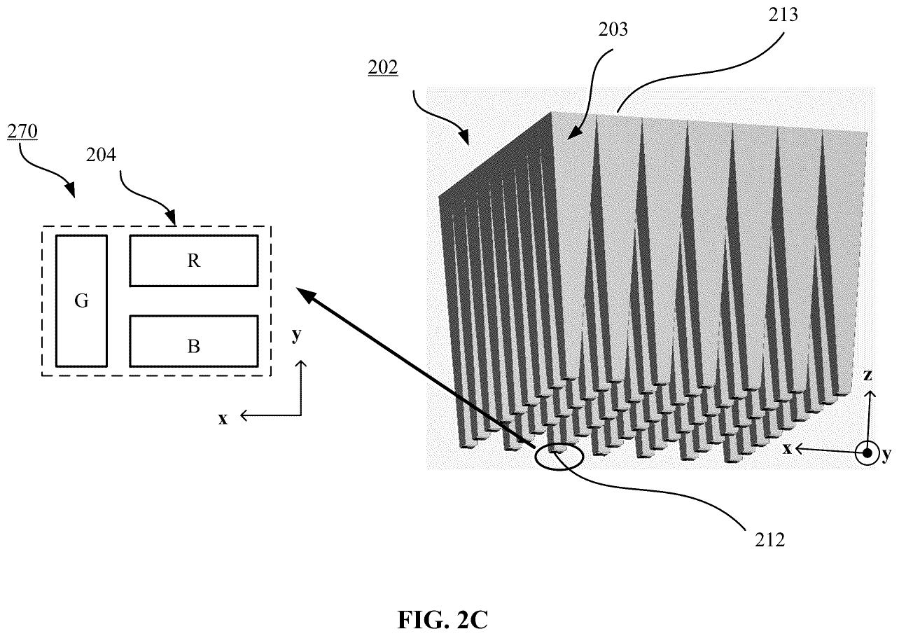

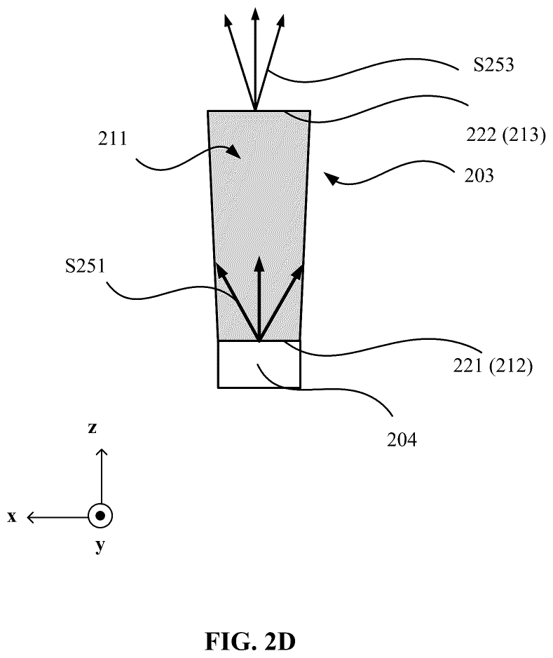

FIG. 2A illustrates a sectional view of a waveguide display system (or assembly) 200 that may be included in an artificial reality system, according to an example of the present disclosure. The waveguide display system 200 may be an example of the waveguide display system included in the left-eye display system 110L or the right-eye display system 110R shown in FIGS. 1A and 1B. The waveguide display system 200 may project a virtual image through the eye-box region 160. In some examples, the waveguide display system 200 may be configured to incorporate dynamic zonal brightness control and spectral mixing control, which enhance both the display performance, power budget, and chromatic content.

In some examples, the waveguide display system 200 may be a pupil-replication (or pupil-expansion) display system. As shown in FIG. 2A, the waveguide display system 200 may include a light source assembly (e.g., a projector) 205, a waveguide 210 coupled with (or including) an in-coupling element 235 and an out-coupling element 245, and a controller 215. The waveguide 210 coupled with (or including) the in-coupling element 235 and the out-coupling element 245 may also be referred to as a light delivery assembly. The light source assembly 205 may be configured to generate and output an image light (or an imaging light field) propagating toward the in-coupling element 235 coupled with the waveguide 210. The waveguide 210 coupled with the in-coupling element 235 and the out-coupling element 245 may be configured to guide the image light received from the light source assembly 205 to propagate through the eye-box region 160 of the waveguide display system 200.

The light source assembly 205 may include an illumination assembly 250, an imaging assembly 260, and a display panel 220. In some examples, the display panel 220 may be a non-emissive display panel, such as a transmissive, reflective, or transflective non-emissive display panel. For example, the non-emissive display panel 220 may be a reflective liquid crystal on silicon (“LCOS”) display panel, or a digital light processing (“DLP”) display panel, etc. In some examples, the light source assembly 205 may be a zonal illuminated projector, which incorporates dynamic zonal brightness control and spectral mixing control, which enhances the display performance, power budget, and chromatic content. The illumination assembly 250 may be configured to output a predetermined illumination (e.g., zonal illumination). The imaging assembly 260 may image the predetermined illumination (e.g., zonal illumination) output from the illumination assembly 250 onto the non-emissive display panel 220. Thus, the illumination assembly 250 and the imaging assembly 260 together may be configured to provide the predetermined illumination (e.g., zonal illumination) to illuminate the non-emissive display panel 220.

The controller 215 may include any suitable hardware (e.g., processor, circuit, gate, switch, etc.) and software (e.g., program code, instruction, etc.) components specifically configured and/or programmed for controlling the illumination assembly 250 and the display panel 220. For example, the controller 215 may include a suitable processor, such as a central processing unit (“CPU”), a graphics processing unit (“GPU”), an application-specific integrated circuit (“ASIC”), a programmable logic device (“PLD”), or any combination thereof. The controller 215 may be electrically connected with the illumination assembly 250 and the display panel 220 through a wireless communication or a wired communication. The controller 215 may receive data, information, or signals from the illumination assembly 250 and/or the display panel 220, or may send data, information, or signals to the illumination assembly 250 and/or the display panel 220. Although the controller 215 is shown as an element separated from the illumination assembly 250, in some examples, the controller 215 may be included in the illumination assembly 250.

The illumination assembly 250 may include a light source array 201 and a concentrator array 202 coupled with the light source array 201. FIG. 2B illustrates an x-y sectional view of the light source array 201 included in the waveguide display system 200 shown in FIG. 2A, according to an example of the present disclosure. As shown in FIGS. 2A and 2B, the light source array 201 may include a plurality of illumination units 204. A light source driving module or circuitry (not shown) may be included in the light source array 201 for driving the illumination units 204. The controller 215 may control the light source driving module or circuitry to individually address the illumination units 204, to provide a zonal illumination of the display panel 220. That is, each illumination unit 204 may be addressed by the light source driving module through the control of the controller 215. In some examples, the illumination units 204 may be divided into a plurality groups, each group may be individually addressable.

The concentrator array 202 may include a plurality of concentrators 203. The concentrators 203 may be non-imaging concentrators. Non-imaging concentrators may be configured to provide the transfer of light radiation between a source and a target without forming an optical image of the source (e.g., the light source array 201). Imaging concentrators may be configured to generate an optical image of the source (e.g., the light source array 201). In some examples, the concentrator array 202 may be a taper array, compound parabolic concentrator (“CPC”) array, or another suitable non-imaging optical concentrator array configured to control the light energy and spectral content based on a predetermined (e.g., an optimum) illumination performance. The concentrator 203 may have reflective and transmissive properties. In some examples, each of the concentrators 203 may correspond to one illumination unit 204 on a one-to-one basis. In some examples, each concentrator 203 may correspond to two or more illumination units 204. In some examples, as shown in FIG. 2A, the illumination unit 204 may be in direct contact with the corresponding concentrator 203 without a gap. In some examples, although not shown, the illumination unit 204 and the corresponding concentrator 203 may be spaced apart from one another by a predetermined gap.

Each illumination unit 204 may include a plurality of light sources configured to emit a plurality of lights of a plurality of primary colors that are mixed according the desired chromatic properties of the waveguide display system 200, such as one or more red light sources, one or more green light sources, and one or more blue light sources. Other chromatic gamut bindings may be achievable through various combinations of the primary light sources. In some examples, each illumination unit 204 may include one or more suitable primary light sources other than the red light sources, green light sources, and blue light sources. In some examples, the light source may include a light-emitting diode (“LED”), a mini-LED, or a micro-LED (“μ-LED”). In some examples, the light source may include another suitable light source other than LED, such as a vertical-cavity surface-emitting laser (“VCSEL”), a photonic-crystal surface emitting laser or another suitable type of in-plane cavity surface emitting laser, a laser diode, a fiber laser, a heterogeneously integrated laser, or a superluminescent light emitting diode (“SLED”), etc.

FIG. 2C illustrates a diagram of the concentrator array 202 and an enlarged diagram of the illumination unit 204 that may be included in the illumination assembly 250 shown in FIG. 2A, according to an example of the present disclosure. For discussion purposes, FIG. 2C shows that each concentrator 203 corresponds to each illumination unit 204. FIG. 2C also illustrates an x-y cross sectional view of color sub-zone configurations of the illumination unit 204, according to an example of the present disclosure. In some examples, each illumination unit 204 may include one or more red sub-zones corresponding to one or more red light sources, one or more green sub-zones corresponding to one or more green light sources, and one or more blue sub-zones corresponding to one or more blue light sources. In some examples, each illumination unit 204 may include one or more suitable color sub-zones other than the red sub-zone, the green sub-zone, and the blue sub-zone.

Using red (R), green (G), and blue (B) colors as examples, the color sub-zone configuration of the illumination unit 204 may take various forms, such as the RGB form shown in FIG. 2C. As shown in FIG. 2C, a color sub-zone configuration 270 may include three color sub-zones corresponding to three light sources: a green sub-zone corresponding to a green light source (e.g., a green LED), a red sub-zone corresponding to a red light source (e.g., a red LED), and a blue sub-zone corresponding to a blue light source (e.g., a blue LED). The three light sources may have different sizes, e.g., the red light source (e.g., red LED) and the blue light source (e.g., blue LED) may have substantially the same size, which may be different from the size of the green light source G (e.g., green LED). The configuration shown in FIG. 2C is merely an example configuration that may be adopted for each illumination unit 204. Different configurations may provide different optical properties.

In some examples, although not shown, the color sub-zones corresponding to different light sources may be arranged in a stack, instead of being disposed in the same plane. For example, the illumination assembly 250 may include a plurality of light source arrays 201 and a plurality of concentrator arrays 202 arranged in a stack. The respective concentrator array 202 may be disposed at the respective light source array 201 associated with respective primary colors.

FIG. 2D illustrates an x-z cross sectional view of the illumination unit 204 and one of the concentrators 203 that may be included in the illumination assembly 250 shown in FIG. 2A, according to an example of the present disclosure. As shown in FIG. 2D, the concentrator 203 may have an input or entrance facet 221 at a light entering portion (e.g., where an input or entrance aperture 212 of the concentrator 203 is located), an output or exit facet 222 at a light exiting portion (e.g., where an output or exit aperture 213 of the concentrator 203 is located), and a concentrator body 211 between the input facet 221 and the output facet 222.

Referring to FIG. 2A and FIG. 2D, the light source array 201 including the illumination units 204 may be configured to emit a plurality of light beams S251 toward the concentrator array 202. The illumination unit 204 may be located adjacent to (e.g., substantially close to) the entrance aperture 212 of the corresponding concentrator 203. The concentrator array 202 may be configured to condition the light beams S251 into corresponding light beams S253 each having a predetermined angular and spatial optical field distribution at the exit aperture 213 of the concentrator 203. In some examples, each of the light beams S253 may have the same predetermined angular and spatial optical field distribution at the exit aperture 213. In some examples, the light beam S251 may have a first solid angle in the three-dimensional space, and the light beam S253 may have a second solid angle in the three-dimensional space, which is smaller than the first solid angle. Moreover, the light beam S253 may have a substantially uniform illumination at the exit aperture 213 of the concentrator 203. For illustrative purposes, FIG. 2A merely shows three light beams (or backlight beams) S253 respectively converted from the light beams (or backlight beams) S251 emitted from three illumination units 204 of the light source array 201, and shows three rays of each light beam S253. For illustrative purposes, FIG. 2A merely shows the light propagation path of a central ray of a central light beam S253 throughout the waveguide display system 200.

Referring to FIG. 2A, the imaging assembly 260 may be configured to guide the light beam S253 received from the illumination assembly 250 as a light beam S255 and focus the light beam S255 onto the non-emissive display panel 220, thereby illuminating the non-emissive display panel 220. That is, the imaging assembly 260 may image the substantially uniform illumination (or irradiance distribution) provided at the exit apertures 213 (shown in FIG. 2D) of the concentrators 203 onto the non-emissive display panel 220. Thus, the non-emissive display panel 220 may be illuminated by the substantially uniform illumination (or irradiance distribution) that is originally provided at the exit apertures 213 (shown in FIG. 2D) of the concentrators 203. The non-emissive display panel 220 may modulate (e.g., spatially and temporally modulate) the light beam S255 and output a light beam S257, which is an image light beam representing at least a portion of a virtual image displayed by the non-emissive display panel 220. Further, the imaging assembly 260 may guide the light beam S257 toward the in-coupling element 235 of the waveguide 210. The waveguide 210 coupled with the in-coupling element 235 and the out-coupling element 245 may guide the light beam S257 to propagate through the eye-box region 160 of the waveguide display system 200.

The imaging assembly 260 may include a polarization beam splitter (“PBS”) 207, a first curved mirror 209, a second curved mirror 229, a first lens assembly 271, and a second lens assembly 281. In some examples, the PBS 207 may be the sole PBS included in the imaging assembly 260. In other words, the imaging assembly 260 may include a single PBS 207. Further, for a given effective focal length of the light source assembly (e.g., the projector) 205, the imaging assembly 260 may utilize a more compact PBS. The type, the size, and the arrangement of the PBS 207 may be determined according to optical design principles that provide the combination of smallest volume, lowest mass and highest optical brightness at the eye-box region 160 of the artificial reality system 100 shown in FIG. 1B.

The PBS 207 may include four surfaces (or sides) configured for light inputting and/or outputting. The first lens assembly 271 may be disposed at a first surface (or side) of the PBS 207, between the concentrator array 202 and the PBS 207. The first lens assembly 271 may include a collection lens. The first curved mirror 209 may be disposed at a second surface (or side) of the PBS 207 opposing to the first surface (or side). The second lens assembly 281 may be disposed at a third surface (or side) of the PBS 207 located between the first surface (or side) and the second surface (or side). The second lens assembly 281 may be disposed between the display panel 220 and the PBS 207. The second lens assembly 281 may include a field lens. The second curved mirror 229 may be disposed at a fourth surface (or side) of the PBS 207 opposing the third surface (or side). The PBS 207 may be disposed between the first lens assembly 271 and the first curved mirror 209, and between the waveguide 210 and the second lens assembly 281. The waveguide 210 may be disposed between the second curved mirror 229 and the PBS 207.

In some examples, the imaging assembly 260 may also include a plurality of polarization conversion elements configured to convert a polarization state of the backlight or the image light, such as one or more quarter-wave plates, one or more linear polarizers, etc. For example, the imaging assembly 260 may include a first quarter-wave plate 291a disposed between the PBS 207 and the first curved mirror 209, and a second quarter-wave plate 291c disposed between the waveguide 210 and the second curved mirror 229. In some examples, the imaging assembly 260 may also include a linear polarizer (not shown) disposed between the PBS 207 and the illumination assembly 250, and the linear polarizer may be configured to polarize the light beam S253 to have a predetermined polarization before the light beam S253 is incident onto the PBS 207, so as to limit the presence of unwanted polarization states that may mitigate the imaging performance.

The waveguide 210 may include an input region where the in-coupling element 235 is disposed, and an output region where the out-coupling element 245 is disposed. Both the PBS 207 and the second curved mirror 229 may face the input region of the waveguide 210. The in-coupling element 235 and the out-coupling element 245 may operate in a predetermined wavelength range that includes at least a portion of the visible wavelength range. In some examples, the in-coupling element 235 may include a reflective polarizer. The reflective polarizer may be configured to substantially transmit a light having a first polarization (e.g., a p-polarized light), and substantially reflect a light having a second, orthogonal polarization (e.g., an s-polarized light). The reflective polarizer included in the in-coupling element 235 may couple, via reflection, the light having the second polarization into a totally internal reflection (“TIR”) path inside the waveguide 210.

The reflective polarizer included in the in-coupling element 235 may be a linearly reflective polarizer or a circularly reflective polarizer. In some examples, the reflective polarizer may be a dielectric multilayer reflective polarizer, a reflective film polarizer, a wire grid polarizer based on liquid crystals, a metallic reflective polarizer, or a solid crystal reflective polarizer, etc. In some examples, the reflective polarizer included in the in-coupling element 235 may include a reflective polarizing film and a substrate for supporting and protecting the reflective polarizing film. The substrate may be optically transparent in the operation wavelength of the waveguide display system 200. In some examples, the reflective polarizer may not include the substrate, and the reflective polarizing film may have a sufficient rigidity, e.g., may be a free-standing layer. In some examples, as shown in FIG. 2A, the reflective polarizer included in the in-coupling element 235 may be embedded in the waveguide 210. In some examples, although not shown, the reflective polarizer may be disposed at a first surface 210-1 or a second, opposing surface 210-2 of the waveguide 210. In some examples, the out-coupling element 245 may be integrally formed as a part of the waveguide 210 at a surface of the waveguide 210. In some examples, the reflective polarizer included in the in-coupling element 235 may be separately formed, and may be disposed at (e.g., affixed to) the corresponding surface. In some examples, the in-coupling element 235 may include one or more diffraction gratings, one or more reflectors, and/or one or more prismatic surface elements, or any combination thereof. A diffraction grating may be a surface relief grating (“SRG”), a volume hologram, a metasurface grating, a holographic polymer-dispersed liquid crystal (“H-PDLC”) grating, a surface relief grating provided (e.g., filled) with LCs, a Pancharatnam-Berry phase (“PBP”) grating, a polarization volume hologram (“PVH”) grating, etc.

In some examples, as shown in FIG. 2A, the out-coupling element 245 may be embedded in the waveguide 210. In some examples, although not shown, the out-coupling element 245 may be disposed at the first surface 210-1 or the second surface 210-2 of the waveguide 210. In some examples, the out-coupling element 245 may be integrally formed as a part of the waveguide 210 at a surface of the waveguide 210. In some examples, the out-coupling element 245 may be separately formed, and may be disposed at (e.g., affixed to) a surface of the waveguide 210. The out-coupling element 245 may include one or more diffraction gratings, one or more reflectors, and/or one or more prismatic surface elements, or any combination thereof. A diffraction grating may be a surface relief grating (“SRG”), a volume hologram, a metasurface grating, a holographic polymer-dispersed liquid crystal (“H-PDLC”) grating, a surface relief grating provided (e.g., filled) with LCs, a Pancharatnam-Berry phase (“PBP”) grating, a polarization volume hologram (“PVH”) grating, etc.

As shown in FIG. 2A, the light beam S253 may be configured (e.g., via the linear polarizer disposed between the PBS 207 and the illumination assembly 250) to have the first polarization. The first lens assembly 271 may convert the light beam S253 output from the illumination assembly 250 into a light beam S252 propagating toward the PBS 207. The light beam S252 may also have the first polarization, e.g., the light beam S252 may be a p-polarized light beam. The PBS 207 may be configured to substantially transmit a light having the first polarization (e.g., a p-polarized light), and substantially reflect a light having the second, orthogonal polarization (e.g., an s-polarized light). Thus, the PBS 207 may substantially transmit the light beam S252 (e.g., p-polarized light beam) toward the stack of the first quarter-wave plate 291a and the first curved mirror 209. The stack of the first quarter-wave plate 291a and the first curved mirror 209 may be configured to convert the light beam S252 having the first polarization (e.g., p-polarized light beam) into a light beam S254 having the second polarization (e.g., an s-polarized light beam) propagating back to the PBS 207. Thus, the PBS 207 may substantially reflect the light beam S254 (e.g., s-polarized light beam) toward the second lens assembly 281 and the display panel 220.

The second lens assembly 281 may convert the light beam S254 (e.g., s-polarized light beam) into the light beam S255 having the second polarization (e.g., s-polarized light beam) propagating toward the display panel 220, and focus the light beam S255 onto the display panel 220. That is, the first lens assembly 271, the PBS 207, the first curved mirror 209, and the second lens assembly 281 together may image (or form an image of) the predetermined illumination distribution at the exit apertures 213 of the concentrator array 202 (shown in FIG. 2C) at the display panel 220, thereby illuminating the display panel 220 under the predetermined illumination distribution.

The display panel 220 may be configured to spatially and temporally modulate the light beam S255 into a light beam S257 propagating back to the second lens assembly 281. The display panel 220 may be configured to provide a quarter-wave retardance to the light beam S255 as the light beam S255 propagates therethrough on a single path. The display panel 220 may also provide a quarter-wave retardance to the light beam S257 as the light beam S257 propagates therethrough on a single path. Thus, the display panel 220 may provide a half-wave retardance to the light beam S255 while reflecting the light beam S255 as the light beam S257. Accordingly, the display panel 220 may convert the polarization state of the light beam S255 to an orthogonal polarization state while reflecting the light beam S255 as the light beam S257. For example, the display panel 220 may be configured to spatially and temporally modulate the light beam S255 having the second polarization (e.g., s-polarized light beam) into the light beam S257 having the first polarization (e.g., p-polarized light beam).

For discussion purposes, in FIG. 2A, the display panel 220 may include a reflective LCOS panel, which may act as a quarter-wave plate at the individual pixel level in its on state. The display panel 220 may include a reflective pixel array facing the PBS 207. For example, the respective display zones (or pixels) of the display panel 220 may spatially and temporally modulate and reflect the respective backlight beams S255 incident onto the display zones as respective light beams S257. The light beam S257 may be an image light beam representing a portion of an image light field associated with a virtual image generated by the display panel 220. A combination of the respective image light beams S257 may form an image light field that represents the entire virtual image generated by the display panel 220.

The second lens assembly 281 may convert the light beam S257 into a light beam S256 (e.g., a p-polarized light beam) propagating toward the PBS 207. The PBS 207 may substantially transmit the light beam S256 (e.g., a p-polarized light beam) toward the input region of the waveguide 210 where the reflective polarizer included in the in-coupling element 235 is disposed. As the reflective polarizer included in the in-coupling element 235 is configured to substantially transmit a light having the first polarization (e.g., a p-polarized light), and substantially reflect a light having the second, orthogonal polarization (e.g., an s-polarized light), the reflective polarizer included in the in-coupling element 235 may substantially transmit the light beam S256 (e.g., p-polarized light beam) toward the stack of the second quarter-wave plate 291c and the second curved mirror 229. That is, the light beam S256 (e.g., p-polarized light beam) may transmit through the waveguide 210 without being coupled into the waveguide 210.

The stack of the second quarter-wave plate 291c and the second curved mirror 229 may be configured to convert the light beam S256 having the first polarization (e.g., p-polarized light beam) into a collimated light beam S259 having the second polarization (e.g., an s-polarized light beam) propagating back to the reflective polarizer included in the in-coupling element 235. The collimated light beam S259 may include a bundle of parallel rays. The reflective polarizer included in the in-coupling element 235 may reflect and couple the light beam S259 (e.g., s-polarized light beam) into the waveguide 210. The reflective polarizer included in the in-coupling element 235 may reflect the light beam S259 (e.g., s-polarized light beam) as an in-coupled light beam S261 propagating inside the waveguide 210 toward the out-coupling element 245 via TIR. The out-coupling element 245 may couple, via deflection, the in-coupled light beam S261 out of the waveguide 210 as one or more output light beams S263 propagating through the eye-box region 160. For illustrative purposes, FIG. 2A merely shows one output light beam S263.

For illustrative purposes, FIG. 2A merely shows the light propagation path of a central ray of a central light beam S253 throughout the waveguide display system 200. The collimated light beam S259 may be incident onto the waveguide 210 (or the reflective polarizer included in the in-coupling element 235) with a predetermined incidence angle. In some example, the reflective polarizer included in the in-coupling element 235 may be configured to couple the collimated light beam S259 into the waveguide 210 with a maximum coupling efficiency. In some examples, the display panel 229 may output an image light having a predetermined incident angle range at the waveguide 210 (or the reflective polarizer included in the in-coupling element 235). The image light may include a plurality of collimated light beams S259 that are incident onto the waveguide 210 (or the reflective polarizer) with a plurality of predetermined incidence angles forming the predetermined incident angle range of the image light). For example, the predetermined incident angle range of the image light may correspond to a predetermined input field of view, while the respective incidence angles of the collimated light beams S259 may correspond to respective input field of view directions across the input field of view. The reflective polarizer may be configured to couple the respective collimated light beams S259 into the waveguide 210 with respective maximum coupling efficiencies. That is, the reflective polarizer may be configured to couple the image light into the waveguide 210 with maximum coupling efficiencies across the entire incident angle range (or the entire input field of view).

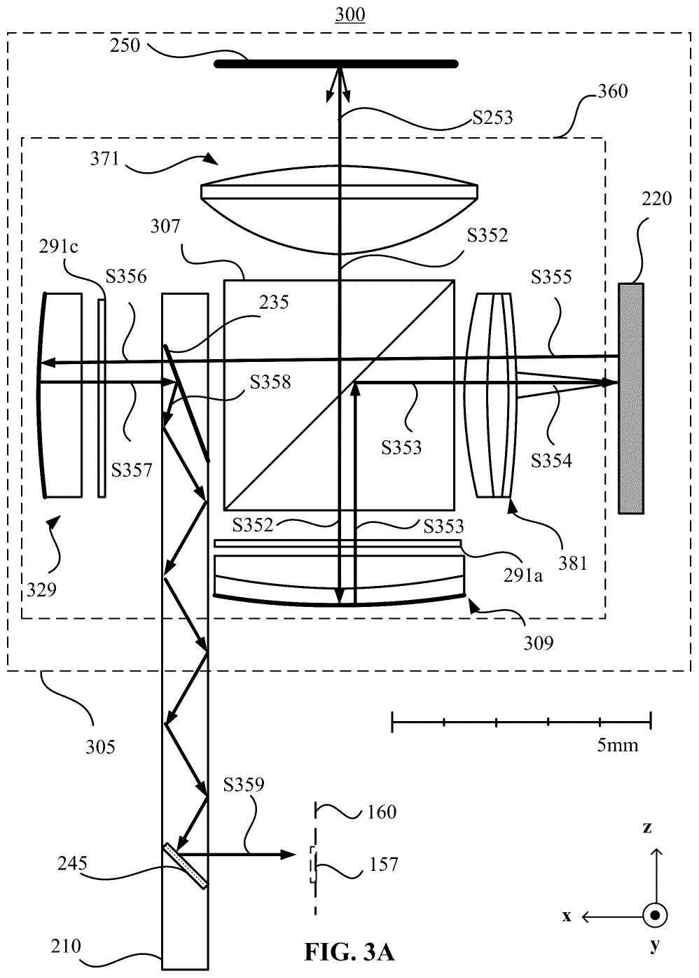

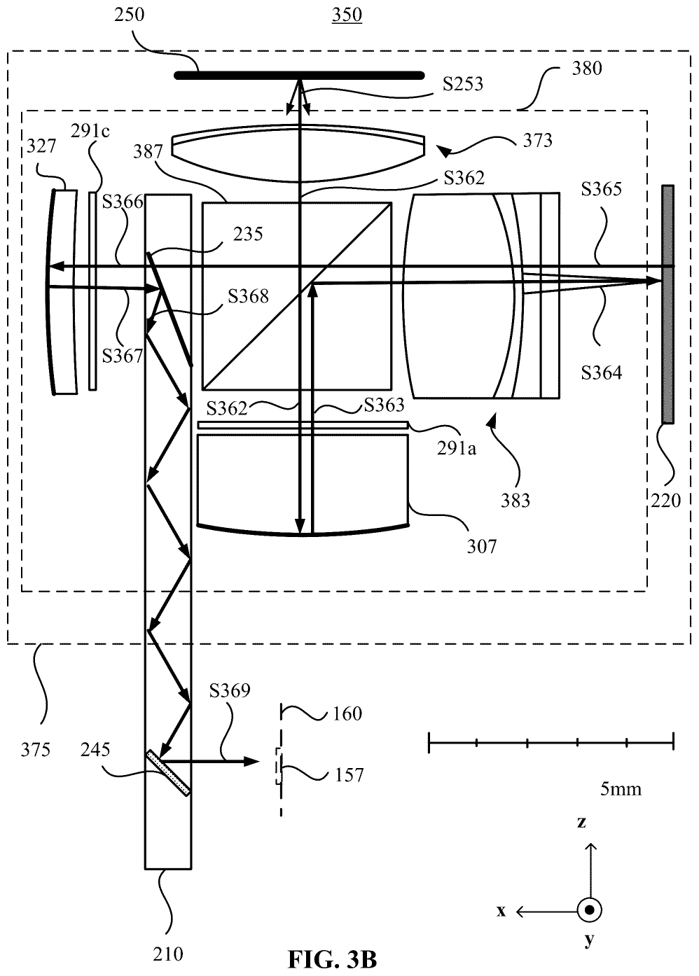

FIG. 3A illustrates an x-z sectional view of a waveguide display system (or assembly) 300 that may be included in an artificial reality system, according to an example of the present disclosure. FIG. 3B illustrates an x-z sectional view of a waveguide display system (or assembly) 350 that may be included in an artificial reality system, according to an example of the present disclosure. The waveguide display system 300 or 350 may include elements, structures, and/or functions that are the same as or similar to those included in the waveguide display system 200 shown in FIGS. 2A-2D. Detailed descriptions of the same or similar elements, structures, and/or functions may refer to the above descriptions rendered in connection with FIGS. 2A-2D.

The waveguide display systems shown in FIGS. 3A and 3B may be exemplary designs of the waveguide display system 200 shown in FIGS. 2A-2D. As shown in FIG. 3A, the waveguide display system 300 may include a light source assembly (e.g., a projector) 305, the waveguide 210 coupled with (or including) the in-coupling element (which may include a reflective polarizer) 235 and the out-coupling element 245, and the controller 215 (not shown in FIG. 3A and FIG. 3B). The light source assembly 305 may include the illumination assembly 250, an imaging assembly 360, and the display panel 220. The imaging assembly 360 may include a PBS 307, a first curved mirror 309, a second curved mirror 329, a first lens assembly 371, and a second lens assembly 381. The imaging assembly 360 may also include the first quarter-wave plate 291a disposed between the PBS 307 and the first curved mirror 309, and the second quarter-wave plate 291c disposed between the waveguide 210 and the second curved mirror 329. The PBS 307 may be similar to the PBS 207 shown in FIG. 2A. Each of the first curved mirror 309 and the second curved mirror 329 may include a plano-concave mirror. The first lens assembly 371 may include a biconvex collection lens (or a biconvex collector), and the second lens assembly 381 may include a biconvex field lens. Each of the first lens assembly 371 and the second lens assembly 381 may be a compound lens. A compound lens may include a plurality of simple lenses cemented together to improve image quality, reduce optical aberrations, and achieve desired magnification, enhancing the overall performance of the optical system.

The light propagation path of the light beam S253 from the illumination assembly 250 to the eye-box region 160 may be similar to that shown in FIG. 2A. The detailed description of the light propagation path of the light beam S253 may refer the corresponding description of FIG. 2A. The light beam S253 output from the illumination assembly 250 may propagate through the PBS 307 a plurality of times (e.g., three times) before the light beam S253 is coupled into the waveguide 210. The first lens assembly (e.g., the collection lens) 371, the PBS 307, and the first curved mirror 309 may form a first birdbath. The second lens assembly (e.g., the field lens) 381, the PBS 307, and the second curved mirror 329 may form a second birdbath.

In the first birdbath, the optical powers of the first lens assembly (e.g., the collection lens) 371 and the first curved mirror 309, and the distance between the first lens assembly (e.g., the collection lens) 371 and the first curved mirror 309 may be configured, such that the first birdbath may convert the divergent light beam S253 into a collimated light beam S353 propagating toward the second lens assembly (e.g., the field lens) 381. In the second birdbath, the optical power of the second lens assembly (e.g., the field lens) 381, and the distance between the second lens assembly (e.g., the field lens) 381 and the display panel 220 may be configured, such that the second lens assembly (e.g., the field lens) 381 may convert the collimated light beam S353 into a light beam S354 that is focused onto the display panel 220. That is, the first birdbath and the second lens assembly (e.g., the field lens) 381 together may provide a nominally telecentric focus at the display panel (e.g., the LCOS) 220. The first birdbath and the second lens assembly (e.g., the field lens) 381 together may image the predetermined illumination distribution at the exit apertures 213 of the concentrator array 202 (included in the illumination assembly 250) at the display panel 220, thereby illuminating the display panel 220 under the predetermined illumination distribution.

The display panel 220 may modulate and reflect the light beam S354 as a divergent light beam S355 (that is an image light beam). In the second birdbath, the optical power of the second curved mirror 309, and the distance between the second lens assembly (e.g., the field lens) 381 and the second curved mirror 329 may also be configured, such that the second birdbath may convert the divergent light beam S355 into a collimated light beam S357 propagating toward the input pupil of the waveguide 210. The second birdbath and the first lens assembly (e.g., the collection lens) 371 together may form the nominal 4F relay, which is desired for a telecentric feed from the illumination assembly 250. The collimated light beam S357 may be coupled into the waveguide 210 via the reflective polarizer included in the in-coupling element 235. The waveguide 210 coupled with the in-coupling element 235 and the out-coupling element 245 may convert the collimated light beam S357 into one or more collimated light beams S359 propagating through the eye-box region 160.

As shown in FIG. 3B, the waveguide display system 350 may include a light source assembly (e.g., a projector) 375, the waveguide 210 coupled with (or including) the in-coupling element 235 (which may include a reflective polarizer) and the out-coupling element 245, and the controller 215 (not shown). The light source assembly 375 may include the illumination assembly 250, an imaging assembly 380, and the display panel 220. The imaging assembly 380 may include a PBS 387, a first curved mirror 307, a second curved mirror 327, a first lens assembly 373, and a second lens assembly 383. The imaging assembly 380 may also include the first quarter-wave plate 291a disposed between the PBS 387 and the first curved mirror 307, and the second quarter-wave plate 291c disposed between the waveguide 210 and the second curved mirror 327. The PBS 387 may be similar to the PBS 207 shown in FIG. 2A. The first curved mirror 307 may include a plano-concave mirror, and the second curved mirror 327 may include a meniscus mirror. The first lens assembly 373 may include a biconvex collection lens (or a biconvex collector), and the second lens assembly 383 may include a biconvex field lens. Each of the first lens assembly 373 and the second lens assembly 383 may be a compound lens.

The light propagation path of the light beam S253 from the illumination assembly 250 to the eye-box region 160 may be similar to that shown in FIG. 2A. The detailed description of the light propagation path of the light beam S253 may refer the corresponding descriptions of FIG. 2A. The light beam S253 output from the illumination assembly 250 may propagate through the PBS 207 three times to be coupled into the waveguide 210. Similar to FIG. 3A, the first lens assembly (e.g., the collection lens) 373, the PBS 387, and the first curved mirror 307 may form a first birdbath. The second lens assembly (e.g., the field lens) 383, the PBS 387, and the second curved mirror 327 may form a second birdbath. The detailed description of the first birdbath and the second birdbath may refer the corresponding description of FIG. 3A.

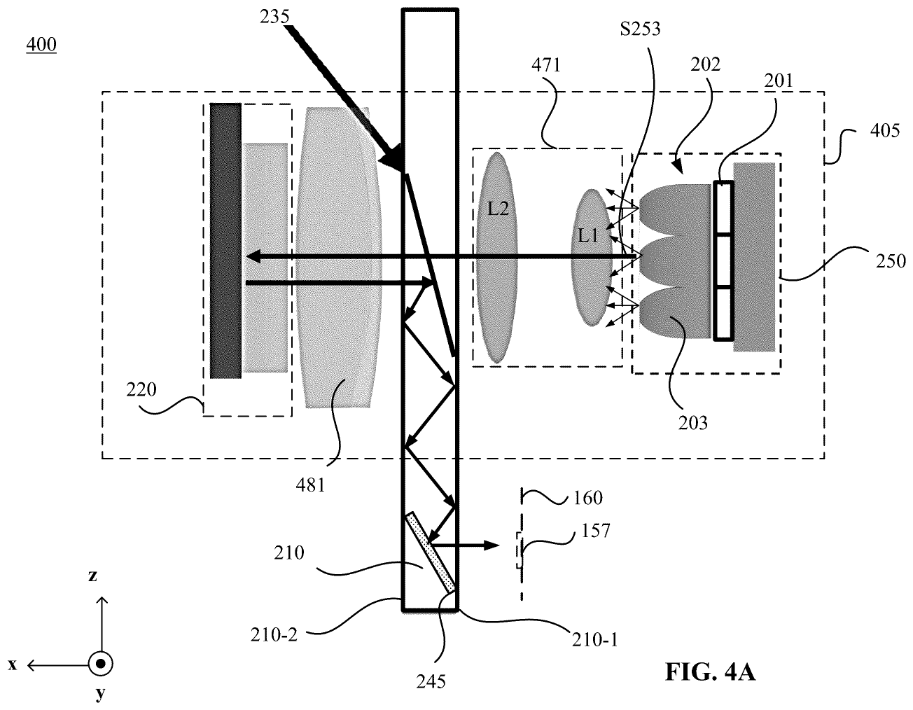

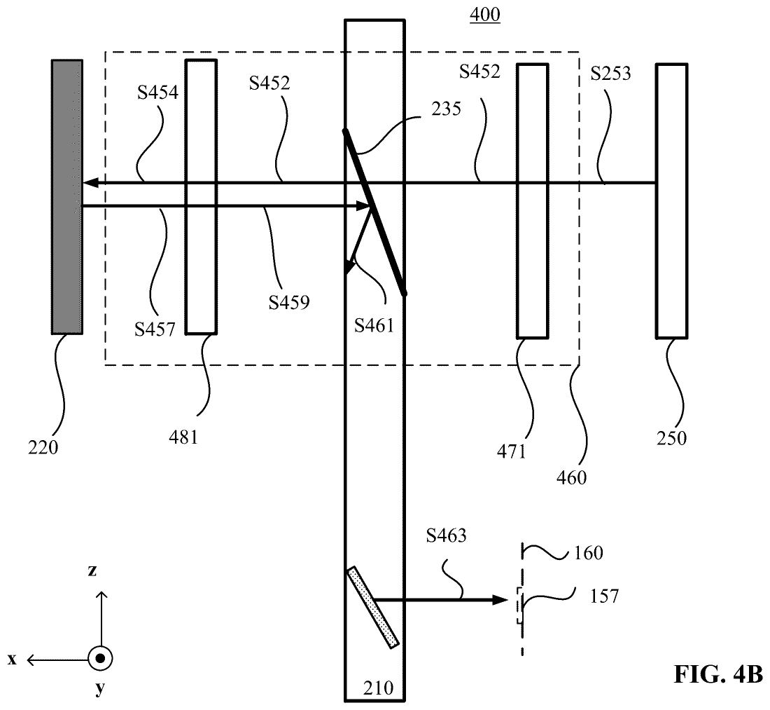

FIG. 4A illustrates an x-z sectional view of a waveguide display system (or assembly) 400 that may be included in an artificial reality system, according to an example of the present disclosure. FIG. 4B illustrates a simplified schematic diagram of the waveguide display system 400, and a light propagation path throughout the waveguide display system 400 shown in FIG. 4A, according to an example of the present disclosure. The waveguide display system 400 may include elements, structures, and/or functions that are the same as or similar to those included in the waveguide display system 200 shown in FIGS. 2A-2D, the waveguide display system 300 shown in FIG. 3A, or the waveguide display system 350 shown in FIG. 3B. Detailed descriptions of the same or similar elements, structures, and/or functions may refer to the above descriptions rendered in connection with FIGS. 2A-2D, FIG. 3A, or FIG. 3B.

As shown in FIGS. 4A and 4B, the waveguide display system 400 may include a light source assembly (e.g., a projector) 405, the waveguide 210 coupled with (or including) the in-coupling element 235 (which may include a reflective polarizer) and the out-coupling element 245, and the controller 215 (not shown). The light source assembly 405 may include the illumination assembly 250, an imaging assembly 460, and the display panel 220. The illumination assembly 250 may include the light source array 201 and the concentrator array 202. The imaging assembly 460 may include a first lens assembly 471 and a second lens assembly 481 arranged in an optical series. In some examples, the first lens assembly 471 may include a collection lens, which may include a first lens L1 and a second lens L2 arranged in an optical series. In some examples, the second lens assembly 481 may include a field lens. The imaging assembly 460 may not include a PBS.

The first lens assembly 471, the second lens assembly 481, the display panel 220, and the illumination assembly 250 may face the input region of the waveguide 210 where the in-coupling element 235 (which may include a reflective polarizer) is disposed. The waveguide 210 and the imaging assembly 460 may be disposed between the illumination assembly 250 and the display panel 220. The first lens assembly 471 and the illumination assembly 250 may be disposed at a first side of the waveguide 210, and the second lens assembly 481 and the display panel 220 may be disposed at a second side of the waveguide 210. The first lens assembly 471 may be disposed between the illumination assembly 250 and the waveguide 210. The second lens assembly 481 may be disposed between the display panel 220 and the waveguide 210. In some examples, the imaging assembly 460 may also include a linear polarizer (not shown) disposed between the first lens assembly 471 and the illumination assembly 250, and the linear polarizer (not shown) may be configured to polarize the light beam S253 to have a predetermined polarization before the light beam S253 is incident onto the first lens assembly 471.

The illumination assembly 250 may be configured to output a predetermined illumination (e.g., zonal illumination). The imaging assembly 460 may image the predetermined illumination (e.g., zonal illumination) output from the illumination assembly 250 onto the non-emissive display panel 220. As shown in FIG. 4A, the illumination assembly 250 may output a plurality of divergent light beams S253 toward the first lens assembly 471. FIG. 4A merely shows three light beams (or backlight beam) S253 output from the respect concentrators 203, and shows three rays of each light beam S253. For discussion purposes, FIGS. 4A and 4B merely shows the light propagation path of a central ray of a central light beam S253 throughout the waveguide display system 400.

As shown in FIG. 4B, the light beam S253 may be configured (e.g., via the linear polarizer disposed between the first lens assembly 471 and the illumination assembly 250) to have the first polarization. For example, the light beam S253 may be a p-polarized light beam. The first lens assembly 471 may convert the light beam S253 into a light beam S452 (e.g., a p-polarized light beam) propagating toward the input region of the waveguide 210 where the reflective polarizer included in the in-coupling element 235 is disposed. As the reflective polarizer included in the in-coupling element 235 is configured to substantially transmit a light having the first polarization (e.g., a p-polarized light), and substantially reflect a light having the second, orthogonal polarization (e.g., an s-polarized light), the reflective polarizer included in the in-coupling element 235 may substantially transmit the light beam S452 (e.g., p-polarized light beam) toward the second lens assembly 481. That is, the light beam S452 (e.g., p-polarized light beam) may transmit through the waveguide 210 without being coupled into the waveguide 210.

The second lens assembly 481 may convert the light beam S452 (e.g., p-polarized light beam) into a light beam S454 (e.g., a p-polarized light beam) that is focused onto the display panel 220. That is, the imaging assembly 460 (including the first lens assembly 471 and the second lens assembly 481) may image (or form an image of) the predetermined illumination distribution at the exit apertures 213 of the concentrator array 202 at the display panel 220, thereby illuminating the display panel 220 under the predetermined illumination distribution.

The display panel 220 may be illuminated by the light beam S454. The display panel 220 may be configured to spatially and temporally modulate the light beam S452 into an image light beam S457 propagating back to the second lens assembly 481. In FIG. 4B, the display panel 220 may be configured to provide a quarter-wave retardance to the light beam S454 as the light beam S454 propagates therethrough on a single path. The display panel 220 may also provide a quarter-wave retardance to the light beam S457 as the light beam S457 propagates therethrough on a single path. Thus, the display panel 220 may provide a half-wave retardance to the light beam S454 while reflecting the light beam S454 as the light beam S457. Accordingly, the display panel 220 may convert the light beam S454 having the first polarization (e.g., p-polarized light beam) into the light beam S457 having the second polarization (e.g., s-polarized light beam).

The second lens assembly 481 may collimate the light beam S457 (e.g., s-polarized light beam) into a collimated light beam S459 (e.g., s-polarized light beam) propagating toward the input region of the waveguide 210 where the reflective polarizer included in the in-coupling element 235 is disposed. The reflective polarizer included in the in-coupling element 235 may reflect and couple the light beam S459 (e.g., s-polarized light beam) into the waveguide 210. The reflective polarizer included in the in-coupling element 235 may reflect the light beam S459 (e.g., s-polarized light beam) as an in-coupled light beam S461 propagating inside the waveguide 210 toward the out-coupling element 245 via TIR. The out-coupling element 245 may couple, via deflection, the in-coupled light beam S461 out of the waveguide 210 as one or more output light beams S463 propagating through the eye-box region 160. For simplicity of illustration, the TIR propagation path from the light beam S461 to the output light beam S463 is not shown.

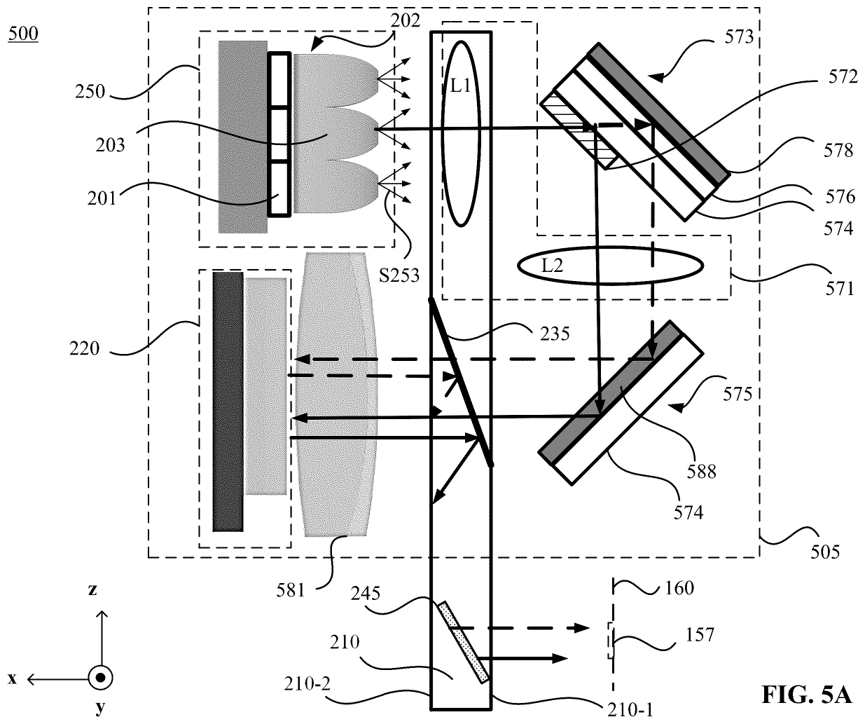

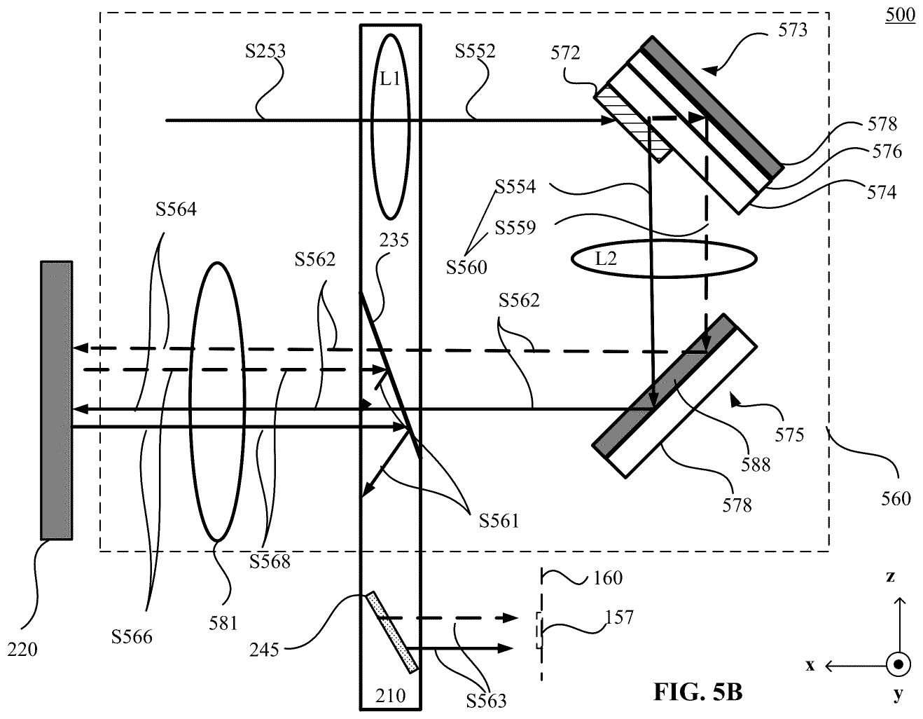

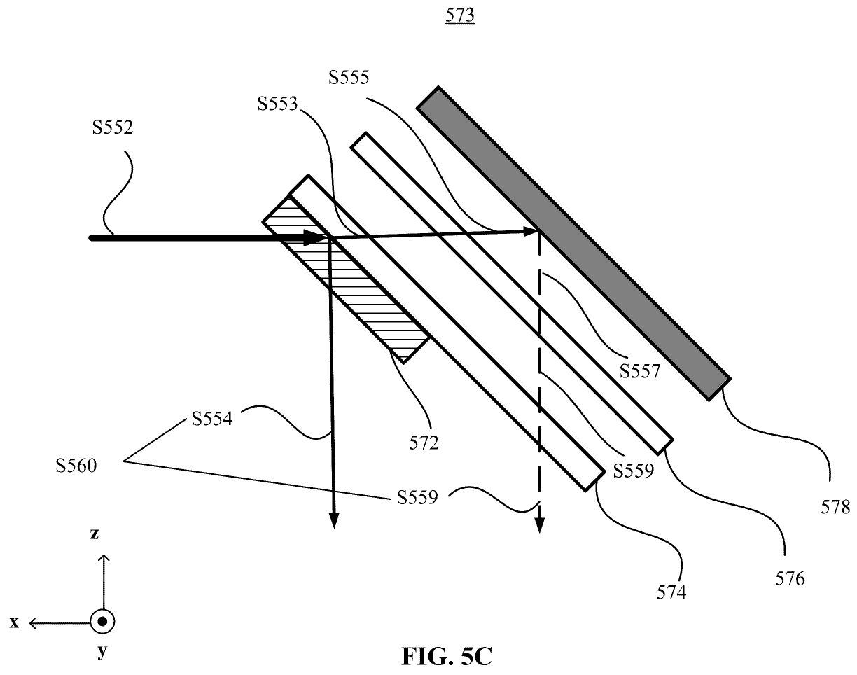

FIG. 5A illustrates an x-z sectional view of a waveguide display system (or assembly) 500 that may be included in an artificial reality system, according to an example of the present disclosure. FIG. 5B illustrates an x-z sectional view of the simplified waveguide display system 500 shown in FIG. 5A. The waveguide display system 500 may include elements, structures, and/or functions that are the same as or similar to those included in the waveguide display system 200 shown in FIGS. 2A-2D, the waveguide display system 300 shown in FIG. 3A, the waveguide display system 350 shown in FIG. 3B, or the waveguide display system 400 shown in FIGS. 4A and 4B. Detailed descriptions of the same or similar elements, structures, and/or functions may refer to the above descriptions rendered in connection with FIGS. 2A-2D, FIGS. 3A and 3B, or FIGS. 4A and 4B.

As shown in FIGS. 5A and 5B, the waveguide display system 500 may include a light source assembly (e.g., a projector) 505, the waveguide 210 coupled with (or including) the in-coupling element 235 (which may include a reflective polarizer) and the out-coupling element 245, and the controller 215 (not shown). The light source assembly 505 may include the illumination assembly 250, an imaging assembly 560, and the display panel 220. The illumination assembly 250 may include the light source array 201 and the concentrator array 202. The imaging assembly 560 may include a first lens assembly 571, a polarization recycling assembly 573, a reflector (e.g., a mirror) 575, and a second lens assembly 581. In some examples, the first lens assembly 571 may include a collection lens, which may include a first lens L1 and a second lens L2 arranged in an optical series. In some examples, the second lens assembly 581 may include a field lens. The imaging assembly 560 may not include a PBS.

The waveguide 210 may be disposed between the display panel 220 and the reflector (e.g., mirror) 575, and between the illumination assembly 250 and the polarization recycling assembly 573. The polarization recycling assembly 573, the second lens L2, and the reflector (e.g., mirror) 575 may be disposed at the first side 210-1 of the waveguide 210. The illumination assembly 250, the display panel 220, and the second lens assembly 581 may be disposed at the second side 210-2 of the waveguide 210. The waveguide 210 may include three regions, a first region that is an input region where the in-coupling element 235 (which may include a reflective polarizer) is disposed, a second region that is an output region where the out-coupling element 245 is disposed, and a third region that is separated from the first region and the second region. In the waveguide 210, the first region (or the input region) may be disposed between the second region (or the output region) and the third region. The reflector (e.g., mirror) 575, the display panel 220, and the second lens assembly 581 may be disposed to face the first region (or the input region) of the waveguide 210. The illumination assembly 250, the first lens L1, and the polarization recycling assembly 573 may be disposed to face the third region of the waveguide 210.

The polarization recycling assembly 573 may be disposed downstream of the first lens L1 in a light path along which a light propagates through the waveguide display system 500, and upstream of the second lens L2 in the light path along which the light propagates through the waveguide display system 500. For discission purposes, FIG. 5A shows that the first lens L1 is embedded in the waveguide 210. In some examples, although not shown, the first lens L1 may be disposed at the first side 210-1 of the waveguide 210, and between the waveguide 210 and the polarization recycling assembly 573. In some examples, although not shown, the first lens L1 may be disposed at the second side 210-2 of the waveguide 210, and between the waveguide 210 and the illumination assembly 250. The reflector (e.g., mirror) 575 may be disposed downstream of the second lens L2 in the light path along which the light propagates through the waveguide display system 500, and upstream of the second lens assembly 581 in the light path along which the light propagates through the waveguide display system 500. The second lens assembly 581 may be disposed downstream of the reflector (e.g., mirror) 575 in the light path along which the light propagates through the waveguide display system 500.

The polarization recycling assembly 573 may include a reflective polarizing layer 572, a substrate 574, a waveplate (or a waveplate layer) 576, and a first reflective layer 578. The reflective polarizing layer 572 may be disposed at a first side of the substrate 574 facing the waveguide 210, and the waveplate 576 and the first reflective layer 578 may be disposed at a second, opposing side of the substrate 574. The waveplate 576 may be disposed between the substrate 574 and the first reflective layer 578. The substrate 574 may support and protect various layers disposed thereat. The reflector (e.g., mirror) 575 may include a second reflective layer 588 disposed at the substrate 574.

In some examples, the substate 574 may have a first region that is covered with the reflective polarizing layer 572, and a second region that is not covered with the reflective polarizing layer 572. In some examples, the reflective polarizing layer 572 may be configured with a size that is half of the size of the substrate 574. For example, the reflective polarizing layer 572 may be disposed to cover only half of the substrate 574, such as the top half shown in FIG. 5A. Each of the waveplate 576 and the first reflective layer 578 may have a size that is substantially the same as the size of the substrate 574.

The illumination assembly 250 may be configured to output a predetermined illumination (e.g., zonal illumination). The imaging assembly 560 may image the predetermined illumination (e.g., zonal illumination) output from the illumination assembly 250 onto the non-emissive display panel 220, with an enhanced optical efficiency. As shown in FIG. 5A, the illumination assembly 250 may output a plurality of divergent light beams S253 toward the first lens L1 included in the first lens assembly 571. FIG. 5A merely shows three light beams (or backlight beam) S253 output from the respect concentrators 203, and shows three rays of each light beam S253. For discussion purposes, FIG. 5A merely shows the light propagation path of a central ray of a central light beam S253 throughout the waveguide display system 500. In FIG. 5A, the light beam S253 may be an unpolarized light beam or partially polarized light beam that includes a first portion having the first polarization and a second portion having the second polarization.

FIG. 5C illustrates the light propagation path of the light beam S253 throughout the polarization recycling assembly 573 included in the waveguide display system 500 shown in FIG. 5A. As shown in FIGS. 5B and 5C, the first lens L1 may convert the light beam S253 into a light beam S552 propagating toward the polarization recycling assembly 573. The light beam S552 may include a first portion having the first polarization (e.g., a p-polarized light) and a second portion having the second polarization (e.g., an s-polarized light). The reflective polarizing layer 572 may be configured to substantially reflect a light having the first polarization (e.g., a p-polarized light), and substantially transmit a light having the second, orthogonal polarization (e.g., an s-polarized light). Thus, the reflective polarizing layer 572 may substantially reflect the first portion having the first polarization (e.g., p-polarized light beam) in the light beam S552 as a light beam S554 (e.g., a p-polarized light beam) propagating toward the reflector (e.g., mirror) 575, and substantially transmit the second portion having the second polarization (e.g., s-polarized light beam) as a light beam S553 (e.g., an s-polarized light beam) propagating toward the first region of the substrate 574.

The first region of the substrate 574 may transmit the light beam S553 (e.g., s-polarized light beam) toward the waveplate 576 while substantially maintaining the polarization of the light beam S553 (e.g., s-polarized light beam). The waveplate 576 may be configured to provide a quarter-wave retardance to the light beam S553 (e.g., s-polarized light beam), and convert the light beam S553 (e.g., s-polarized light beam) into a light beam S555 propagating toward the first reflective layer 578. The light beam S555 may be a circularly polarized light beam having the first handedness, such as a right-handed circularly polarized light beam. The first reflective layer 578 may reflect the light beam S555 back to the waveplate 576 as a light beam S557. The light beam S557 may be a circularly polarized light beam having the second handedness orthogonal to the first handedness, e.g., the light beam S557 may be a left-handed circularly polarized light beam. The waveplate 576 may convert the light beam (e.g., left-handed circularly polarized light beam) S557 into a light beam S559 (e.g., a p-polarized light beam) propagating toward the second region of the substrate 574. That is, the stack of the waveplate 576 and the first reflective layer 578 may convert the light beam S553 (e.g., s-polarized light beam) into the light beam S559 (e.g., a p-polarized light beam).

The second region of the substrate 574 may transmit the light beam S559 (e.g., p-polarized light beam) toward the reflector (e.g., mirror) 575. Thus, the second portion of the light beam S552 (e.g., the light beam S553), which would otherwise be lost in a conventional display system, is recycled as the light beam S559 (e.g., p-polarized light beam) transmitted through the substrate 574 toward the mirror 575. For discussion purposes, a combination of the light beam S554 (e.g., p-polarized light beam) and the light beam S559 (e.g., p-polarized light beam) propagating toward the mirror 575 may be referred to as a light beam S560 (e.g., p-polarized light beam).

Referring back to FIG. 5B, the reflector (e.g., mirror) 575 may reflect the light beam S560 (e.g., p-polarized light beam) as a light beam S562 (e.g., a p-polarized light beam) propagating toward the input region of the waveguide 210 where the reflective polarizer included in the in-coupling element 235 is disposed. The reflective polarizer included in the in-coupling element 235 may substantially transmit the light beam (e.g., p-polarized light beam) S562 having the first polarization toward the second lens assembly 581. That is, the light beam S562 may transmit through the waveguide 210 without being coupled into the waveguide 210. The second lens assembly 581 may convert the light beam S562 (e.g., p-polarized light beam) into a light beam S564 (e.g., p-polarized light beam) propagating toward the display panel 220, and focus the light beam S564 (e.g., p-polarized light beam) onto the display panel 220. That is, the imaging assembly 560 may image (or form an image of) the predetermined illumination distribution at the exit apertures 213 of the concentrator array 202 at the display panel 220, thereby illuminating the display panel 220 under the predetermined illumination distribution.

The light prorogation path of the light beam S564 (e.g., p-polarized light beam) shown in FIG. 5B may be similar to that of the light beam S454 (e.g., p-polarized light beam) shown in FIG. 4B. For example, the display panel 220 may be configured to convert the backlight beam S564 (e.g., p-polarized light beam) into an image light beam S566 (e.g., an s-polarized light beam) propagating back to the second lens assembly 581. The second lens assembly 581 may collimate the light beam S566 (e.g., s-polarized light beam) into a collimated light beam S568 (e.g., s-polarized light beam) propagating toward the input region of the waveguide 210. The reflective polarizer included in the in-coupling element 235 may reflect and couple the light beam S568 (e.g., s-polarized light beam) into the waveguide 210. The reflective polarizer included in the in-coupling element 235 may reflect the light beam S568 (e.g., s-polarized light beam) as an in-coupled light beam S561 propagating inside the waveguide 210 toward the out-coupling element 245 via TIR. The out-coupling element 245 may couple, via deflection, the in-coupled light beam S561 out of the waveguide 210 as one or more output light beams S563 propagating through the eye-box region 160.

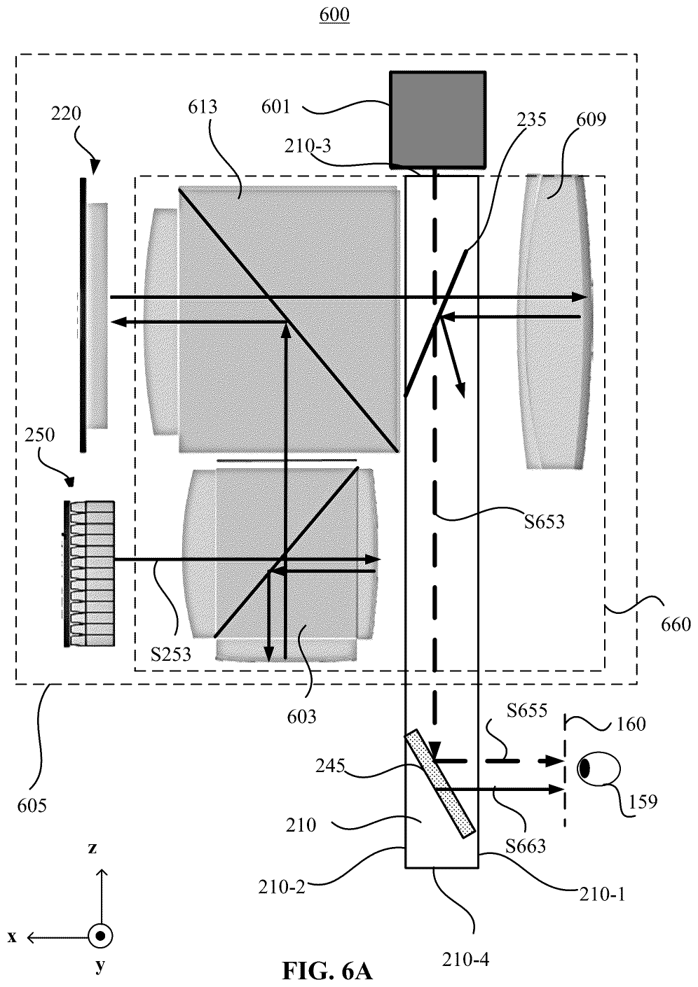

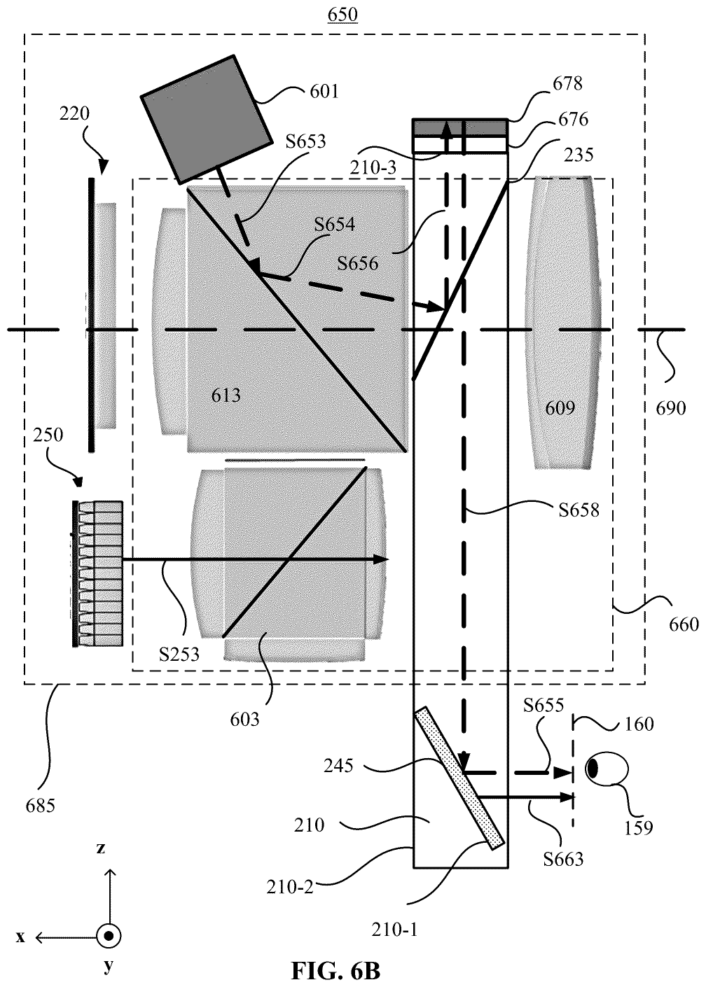

The compact waveguide display systems disclosed herein may also provide a capability to integrate another optical function, such as an eye tracking and/or a face tracking, into the same waveguide as the display channel while maintaining a low-profile hardware configuration. FIGS. 6A and 6B illustrates examples of a waveguide display system that includes a light source assembly (e.g., a project) integrated with an infrared light source. FIG. 6A illustrates an x-z sectional view of a waveguide display system (or assembly) 600, according to an example of the present disclosure. The waveguide display system 600 may include elements, structures, and/or functions that are the same as or similar to those included in the waveguide display system 200 shown in FIGS. 2A-2D, the waveguide display system 300 shown in FIG. 3A, the waveguide display system 350 shown in FIG. 3B, the waveguide display system 400 shown in FIGS. 4A and 4B, or the waveguide display system 500 shown in FIGS. 5A-5C. Detailed descriptions of the same or similar elements, structures, and/or functions may refer to the above descriptions rendered in connection with FIGS. 2A-2D, FIGS. 3A-3B, FIGS. 4A-4B, or FIGS. 5A-5C.

As shown in FIG. 6A, the waveguide display system 600 may include a light source assembly (e.g., a projector) 605, the waveguide 210 coupled with (or including) the in-coupling element 235 (which may include a reflective polarizer) and the out-coupling element 245, and the controller 215 (not shown). The light source assembly 605 may include the illumination assembly 250, an imaging assembly 660, the display panel 220, and an eye-tracking illuminator (e.g., an infrared (“IR”) light source) 601. The illumination assembly 250 and the display panel 220 may be disposed at the second side 210-2 of the waveguide 210. The imaging assembly 660 may be a suitable imaging assembly disclosed herein, such as the imaging assembly 260 shown in FIG. 2A, the imaging assembly 360 shown in FIG. 3A, the waveguide display system 380 shown in FIG. 3B, the imaging assembly 460 shown in FIG. 4B, or the imaging assembly 560 shown in FIG. 5B. The imaging assembly 660 and the waveguide 210 coupled with (or including) the in-coupling element 235 and the out-coupling element 245 may guide the light beam S253 output from the illumination assembly 250 as an image light beam S663 propagating through the eye-box region 160 where the eye 159 of the user is positioned.

For discussion purposes, FIG. 6A shows that the imaging assembly 660 includes a first PBS 603, a second PBS 613, and a lens assembly 609. The first PBS 603 may be coupled with one or more lenses and one or more curved mirrors, and the second PBS 613 may be coupled with one or more lenses. The lens assembly 609 may include one or more lenses coupled with a curved mirror. In some examples, the imaging assembly 660 may also include one or more quarter-wave plates, a linear polarizer, etc. The first PBS 603 and the second PBS 613 may be disposed at the second side 210-2 of the waveguide 210, and the lens assembly 609 may be disposed at the first side 210-1 of the waveguide 210. The lens assembly 609 and the second PBS 613 may be disposed to face the display panel 220. The lens assembly 609, the second PBS 613, and the display panel 220 may be disposed to face the input region of the waveguide 210. The first PBS 603 may be disposed to face the illumination assembly 250. The first PBS 603 and the illumination assembly 250 may be disposed to face a region of the waveguide 210 located between the in-coupling element 235 (which may include a reflective polarizer) and the out-coupling element 245.

In the sample shown in FIG. 6A, the first PBS 603 and the second PBS 205 may be configured to have different polarization dependency. For example, the first PBS 603 may be configured to substantially reflect a light having the first polarization (e.g., a p-polarized light), and substantially transmit a light having the second, orthogonal polarization (e.g., an s-polarized light). The second PBS 613 may be configured to substantially transmit a light having the first polarization (e.g., a p-polarized light), and substantially reflect a light having the second, orthogonal polarization (e.g., an s-polarized light).

The IR light source 601 may be positioned out of a line of sight of the user (e.g., above and in front of the eye 159). As shown in FIG. 6A, the IR light source 601 may be disposed at or adjacent to (e.g., close to) a third side (or surface) 210-3 of the waveguide 210. The waveguide 210 may also have a fourth side (or surface) 210-4 that is opposite to the third side (or surface) 210-3. The waveguide 210 may be a rectangular prism having two base surfaces and four lateral surfaces. The first surface 210-1 and the second surface 210-2 of the waveguide 210 may correspond to two of the four lateral surfaces, while the third surface 210-3 and the fourth surface 210-4 may correspond to the two base surfaces of the waveguide 210. The third surface 210-3 may be located relatively close to the input region and relatively far away from the output region of the waveguide 210. The fourth surface 210-4 may be located relatively close to the output region and relatively far away from the input region of the waveguide 210.

The IR light source 601 may emit an IR light S653 to illuminate the eye 159 positioned within the eye-box region 160. For example, the emitting wavelength range of the IR light source 601 (or the wavelength range of the IR light S653) may be within, overlap, or encompass at least a portion of the IR wavelength range. In some examples, the emitting wavelength range of the IR light source 601 (or the wavelength range of the IR light S653) may be in the near infrared (“NIR”) wavelength range, or another suitable IR wavelength range such that the IR light S653 is not visible by the eye 159. IR lights are not visible to human eyes and, thus, do not distract the user during operations. In some examples, the IR light source 601 may be configured to provide a structured light to illuminate the eye 159, or a structured illumination (or structured light pattern) to the eye 159. The structured illumination may increase the tracking accuracy of the eye 159. In some examples, the structured illumination may also enable the depth reconstruction of a tracked object, such as the face. The structured light may include at least one of an intensity-based structured light or a polarization-based structured light.

The IR light source 601 may emit the IR light S653 directly into the waveguide 210. The IR light S653 may propagate within the waveguide 210 toward the in-coupling element 235 (which may include a reflective polarizer), and subsequently toward the out-coupling element 245, without undergoing TIR at the surfaces of the waveguide 210. In some examples, the operation wavelength range of the reflective polarizer included in the in-coupling element 235 may be configured to lie outside of the emitting wavelength range of the IR light source 601 (or the wavelength range of the IR light S653) and, thus, the reflective polarizer included in the in-coupling element 235 may substantially transmit the IR light S653 toward the out-coupling element 245. In some examples, the operation wavelength range of the reflective polarizer included in the in-coupling element 235 may be configured to encompass the emitting wavelength range of the IR light source 601 (or the wavelength range of the IR light S653), and the IR light S653 may be confirmed to have the first polarization (e.g., a p-polarized light). As the reflective polarizer included in the in-coupling element 235 is configured to substantially transmit a light having the first polarization (e.g., a p-polarized light), and substantially reflect a light having the second, orthogonal polarization (e.g., an s-polarized light), the reflective polarizer included in the in-coupling element 235 may substantially transmit the IR light S653 toward the out-coupling element 245.

The operation wavelength range of the out-coupling element 245 may be configured to encompass the emitting wavelength range of the IR light source 601 (or the wavelength range of the IR light S653). Thus, the out-coupling element 245 may couple the IR light S653, e.g., via reflection, out of the waveguide 210 as an IR light S655 propagating through the eye-box region 160. The IR light S655 may illuminate the pupil area of the eye 159, the entire eye 159, and/or an area surrounding the eye 159, including the eye lid and/or the facial skins or other tissues around or inside the eye 159. An optical sensor (e.g., camera) may be positioned to receive an IR light reflected from such regions in or around the eye 159 illuminated under the IR light S655, and generate a tracking signal (e.g., an image) of the eye 159.

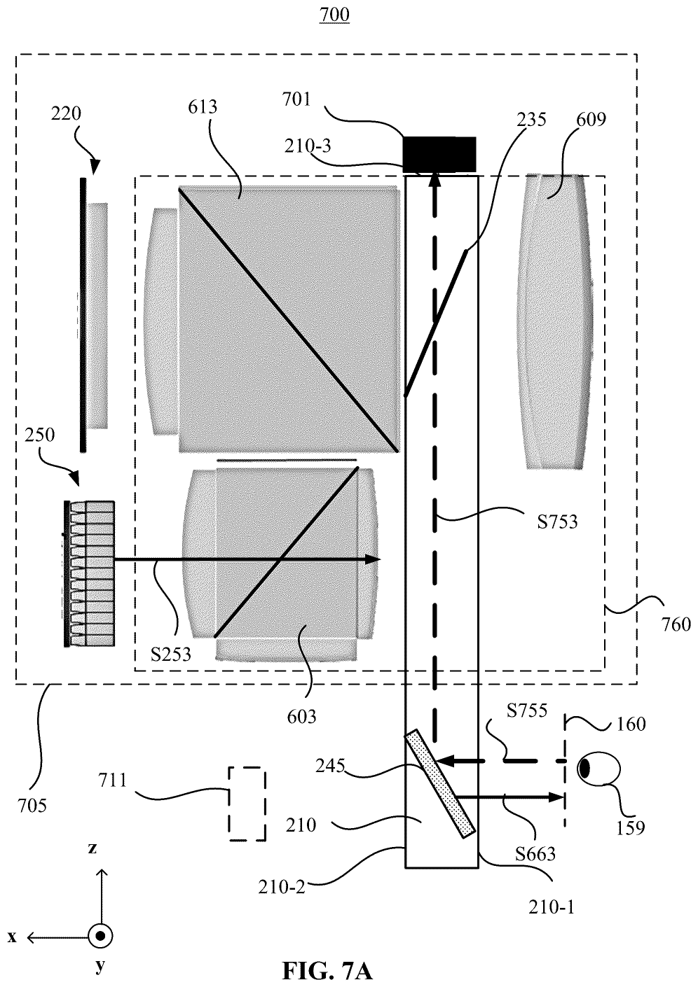

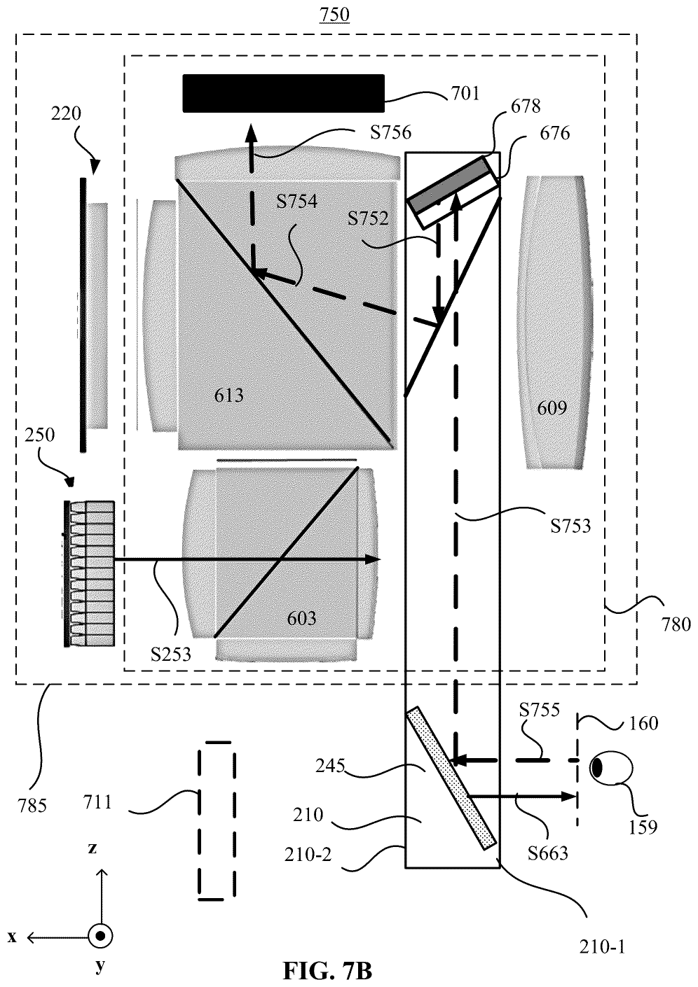

FIG. 6B illustrates an x-z sectional view of a waveguide display system (or assembly) 650, according to an example of the present disclosure. The waveguide display system 650 may include elements, structures, and/or functions that are the same as or similar to those included in the waveguide display system 600 shown in FIG. 6A. As shown in FIG. 6B, the waveguide display system 650 may include a light source assembly (e.g., a projector) 685, the waveguide 210 coupled with (or including) the in-coupling element 235 (which may include a reflective polarizer) and the out-coupling element 245, and the controller 215 (not shown). The light source assembly 685 may include the illumination assembly 250, the imaging assembly 660, the display panel 220, and the eye-tracking illuminator (e.g., the IR light source) 601. The waveguide 210 may also be coupled with a stack of a waveplate 676 and a reflective layer 678. In some examples, as shown in FIG. 7A, the stack of the waveplate 676 and the reflective layer 678 may be disposed at or adjacent to (e.g., close to) the third surface 210-3. In some examples, although not shown, the stack of the waveplate 676 and the reflective layer 678 may be embedded inside a portion of the waveguide 210 between the reflective polarizer included in the in-coupling element 235 and the third surface 210-3. The operation wavelength range of the reflective layer 678 may be configured to encompass the emitting wavelength range of the IR light source 601. The waveplate 676 may be configured to provide a quarter-wave retardance to the IR light S653.

The second PBS 613 may have a first side facing the display panel 220, a second side opposing to the first side and facing the waveguide 210, a third side facing the first PBS 603, and a fourth side opposing to the third side. The IR light source 601 may be disposed at the fourth side of the second PBS 613. In some examples, as shown in FIG. 6B, the IR light source 601 may be disposed adjacent to the stack of the waveplate 676 and the reflective layer 678, and may be disposed obliquely with respect to an optical axis 690 of the second PBS 613. In some examples, although not shown, the IR light source 601 may be configured with an optical axis perpendicular to the optical axis 690 of the second PBS 613. The IR light source 601 may emit the IR light S653 directly into the second PBS 613. The IR light S653 may be configured to be a light having the second polarization (e.g., an s-polarized light) and, thus, the second PBS 613 may substantially reflect the IR light S653 (e.g., s-polarized light) as an IR light S654 having the second polarization (e.g., an s-polarized light) propagating toward the input region of the waveguide 210 where the reflective polarizer included in the in-coupling element 235 is disposed.

The operation wavelength range of the reflective polarizer included in the in-coupling element 235 may be configured to encompass the emitting wavelength range of the IR light source 601 (or the wavelength range of the IR light S653). As the reflective polarizer included in the in-coupling element 235 is configured to substantially transmit a light having the first polarization (e.g., a p-polarized light), and substantially reflect a light having the second, orthogonal polarization (e.g., an s-polarized light), the reflective polarizer included in the in-coupling element 235 may substantially reflect the IR light S654 (e.g., s-polarized light) as an IR light S656 having the second polarization (e.g., an s-polarized light) propagating toward the stack of the waveplate 676 and the reflective layer 678.

The stack of the waveplate 676 and the reflective layer 678 may be configured to convert the IR light S656 having the second polarization (e.g., s-polarized light) into an IR light S658 having the first polarization (e.g., a p-polarized light), and reflect the IR light S656 back to the reflective polarizer included in the in-coupling element 235 as the IR light S658. The reflective polarizer included in the in-coupling element 235 may substantially transmit the IR light S658 (e.g., p-polarized light) toward the out-coupling element 245, without undergoing TIR at the surfaces of the waveguide 210. The out-coupling element 245 may couple the IR light S658, e.g., via reflection, out of the waveguide 210 as an IR light S663 propagating through the eye-box region 160 to illuminate the eye 159.

FIGS. 7A and 7B illustrates examples of waveguide display systems that include a light source assembly (e.g., a project) integrated with an optical sensor. FIG. 7A illustrates an x-z sectional view of a waveguide display system (or assembly) 700, according to an example of the present disclosure. The waveguide display system 700 may include elements, structures, and/or functions that are the same as or similar to those included in the waveguide display system 200 shown in FIGS. 2A-2D, the waveguide display system 300 shown in FIG. 3A, the waveguide display system 350 shown in FIG. 3B, the waveguide display system 400 shown in FIGS. 4A and 4B, the waveguide display system 500 shown in FIGS. 5A-5C, the waveguide display system 600 shown in FIG. 6A, or the waveguide display system 650 shown in FIG. 6B. Detailed descriptions of the same or similar elements, structures, and/or functions may refer to the above descriptions rendered in connection with FIGS. 2A-2D, FIGS. 3A-3B, FIGS. 4A-4B, FIGS. 5A-5C, FIG. 6A, or FIG. 6B.

As shown in FIG. 7A, the waveguide display system 700 may include a light source assembly (e.g., a projector) 705, the waveguide 210 coupled with (or including) the in-coupling element 235 (which may include a reflective polarizer) and the out-coupling element 245, and the controller 215 (not shown). The light source assembly 705 may include the illumination assembly 250, an imaging assembly 760, the display panel 220, and an optical sensor (e.g., a camera) 701. The optical sensor 701 may include a camera, or a photodiode, etc., such as one or more of a charge-coupled device (“CCD”) camera, a complementary metal-oxide-semiconductor (“CMOS”) sensor, an N-type metal-oxide-semiconductor (“NMOS”) sensor, a pixelated polarized camera, or any other optical sensors.

The imaging assembly 760 may be a suitable imaging assembly disclosed herein, such as the imaging assembly 260 shown in FIG. 2A, the imaging assembly 360 shown in FIG. 3A, the imaging assembly 380 shown in FIG. 3B, the imaging assembly 460 shown in FIG. 4B, the imaging assembly 560 shown in FIG. 5B, or the imaging assembly 660 shown in FIGS. 6A and 6B. For discussion purposes, FIG. 7A shows that the imaging assembly 760 is similar to the imaging assembly 660 shown in FIGS. 6A and 6B. The imaging assembly 760 and the waveguide 210 coupled with (or including) the in-coupling element 235 and the out-coupling element 245 may guide the light beam S253 output from the illumination assembly 250 as an image light beam S663 propagating through the eye-box region 160 where the eye 159 of the user is positioned.

As shown in FIG. 7A, the optical sensor 701 may be disposed at or adjacent to (e.g., close to) the third surface 210-3 of the waveguide 210. The eye 159 of the user positioned within the eye-box region 160 may be illuminated by an IR light emitted from an IR light source (not shown). The IR light illuminating the eye 159 may be reflected as an IR light S755 by a pupil area of the eye 159, the entire eye 159, or an area surrounding the eye 159, including the eye lid and/or the facial skins or other tissues around or inside the eye 159. For discussion purposes, the light reflected by such regions in or around the eye 159 is simply referred to as a light reflected by the eye 159. The IR light S755 may propagate toward the out-coupling element 245. The operation wavelength range of the out-coupling element 245 may be configured to encompass the emitting wavelength range of the IR light source (not shown). The out-coupling element 245 may be configured to deflect the IR light S755 as an IR light S753 propagating directly toward the reflective polarizer included in the in-coupling element 235 and the optical sensor 701, without undergoing TIR at the surfaces of the waveguide 210.

In some examples, the operation wavelength range of the reflective polarizer included in the in-coupling element 235 may be configured to lie outside the emitting wavelength range of the IR light source (or the wavelength range of the IR light S755) and, thus, the reflective polarizer included in the in-coupling element 235 may substantially transmit the IR light S753 toward the out-coupling element 245. In some examples, the operation wavelength range of the reflective polarizer included in the in-coupling element 235 may be configured to encompass the emitting wavelength range of the IR light source (or the wavelength range of the IR light S755), and the IR light S753 may be confirmed to have the first polarization (e.g., a p-polarized light). As the reflective polarizer included in the in-coupling element 235 is configured to substantially transmit a light having the first polarization (e.g., a p-polarized light), and substantially reflect a light having the second, orthogonal polarization (e.g., an s-polarized light), the reflective polarizer included in the in-coupling element 235 may substantially transmit the IR light S753 toward the optical sensor 701. The optical sensor 701 may generate a tracking signal of the eye 159 based on the received IR light S753.

Thus, the waveguide 210 coupled with the reflective polarizer included in the in-coupling element 235 and the out-coupling element 245 may bring the optical sensor 701 virtually to the front of the eye 159, forming a virtual, direct view optical sensor (e.g., camera) 711 arranged in front of the eye 159. The virtual, direct view camera 711 may provide an in-field imaging of the eye 159. “Field” in the phrases “out-of-field imaging” and “in-field imaging” refers to a field of view of an eye of a user when using a system or device including the elements that provide the out-of-field (or in-field) imaging of the eye 159. The “in-field imaging” of the eye 159 may provide a larger tracking range when the eye 159 moves or rotates in the horizontal and/or vertical directions. Thus, the disclosed waveguide display system 700 including the integrated optical sensor 701 may enhance the accuracy of the eye tracking and improve the user experience.

FIG. 7B illustrates an x-z sectional view of a waveguide display system (or assembly) 750, according to an example of the present disclosure. The waveguide display system 750 may include elements, structures, and/or functions that are the same as or similar to those included in the waveguide display system 600 shown in FIG. 6A, the waveguide display system 650 shown in FIG. 6B, or the waveguide display system 700 shown in FIG. 7A. As shown in FIG. 7B, the waveguide display system 750 may include a light source assembly (e.g., a projector) 785, the waveguide 210 coupled with (or including) the in-coupling element 235 and the out-coupling element 245, and the controller 215 (not shown). The light source assembly 785 may include the illumination assembly 250, an imaging assembly 780, the display panel 220, and the optical sensor 701. The imaging assembly 780 shown in FIG. 7B may be similar to the imaging assembly 760 shown in FIG. 7A, and the imaging assembly 780 may also include an extra lens disposed at the fourth side of the second PBS 613, between the second PBS 613 and the optical sensor 701.

The waveguide 210 may also be coupled with a stack of the waveplate 676 and the reflective layer 678. In some examples, as shown in FIG. 7B, the stack of the waveplate 676 and the reflective layer 678 may be embedded inside a portion of the waveguide 210 between the reflective polarizer included in the in-coupling element 235 and the third side 210-3. In some examples, although not shown, the stack of the waveplate 676 and the reflective layer 678 may be disposed at or adjacent to (e.g., close to) the third surface 210-3. The operation wavelength range of the reflective layer 678 may be configured to encompass emitting wavelength range of the IR light source (or the wavelength range of the IR light S755 reflected from the eye 159). The waveplate 676 may be configured to provide a quarter-wave retardance to the IR light S755 reflected from the eye 159. The optical sensor 701 may be disposed adjacent to the stack of the waveplate 676 and the reflective layer 678, e.g., disposed at the fourth side of the second PBS 613.

The IR light S755 may propagate toward the out-coupling element 245. The operation wavelength range of the out-coupling element 245 may be configured to encompass the emitting wavelength range of the IR light source (not shown). The out-coupling element 245 may be configured to deflect the IR light S755 as the IR light S753 propagates directly toward the reflective polarizer included in the in-coupling element 235, without undergoing TIR at the surfaces of the waveguide 210. The IR light S755 and the IR light S753 may be configured to first polarization (e.g., p-polarized light). The operation wavelength range of the reflective polarizer included in the in-coupling element 235 may be configured to encompass the emitting wavelength range of the IR light source (not shown). The reflective polarizer included in the in-coupling element 235 is configured to substantially transmit a light having the first polarization (e.g., a p-polarized light), and substantially reflect a light having the second, orthogonal polarization (e.g., an s-polarized light), the reflective polarizer included in the in-coupling element 235 may substantially transmit the S753 (e.g., p-polarized light) toward the stack of the waveplate 676 and the reflective layer 678.

The stack of the waveplate 676 and the reflective layer 678 may be configured to convert the IR light S753 having the first polarization (e.g., p-polarized light) into an IR light S752 having the second polarization (e.g., an s-polarized light), and reflect the IR light S753 back to the reflective polarizer included in the in-coupling element 235 as the IR light S752. The reflective polarizer included in the in-coupling element 235 may substantially transmit the IR light S752 having the second polarization (e.g., s-polarized light) toward the second PBS 613. The second PBS 613 may substantially reflect the IR light S754 (e.g., s-polarized light) as an IR light S756 having the second polarization (e.g., an s-polarized light) propagating toward the optical sensor 701. The optical sensor 701 may generate a tracking signal (e.g., an image) of the eye 159 based on the received IR light S753. Thus, the waveguide 210 coupled with the reflective polarizer included in the in-coupling element 235, the out-coupling element 245, and the stack of the waveplate 676 and the reflective layer 678 may bring the optical sensor 701 virtually to the front of the eye 159, forming the virtual, direct view optical sensor (e.g., camera) 711 arranged in front of the eye 159. Accordingly, the disclosed waveguide display system 750 including the integrated optical sensor 701 may enhance the accuracy of the eye tracking and improve the user experience.

Any of the steps, operations, or processes described herein may be performed or implemented with one or more hardware and/or software modules, alone or in combination with other devices. A software module may be implemented with a computer program product including a computer-readable medium containing computer program code, which can be executed by a computer processor for performing any or all of the steps, operations, or processes described. In some examples, a hardware module may include hardware components such as a device, a system, an optical element, a controller, an electrical circuit, a logic gate, etc.

Embodiments of the disclosure may also relate to an apparatus for performing the operations herein. This apparatus may be specially constructed for the specific purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. The non-transitory computer-readable storage medium can be any medium that can store program codes, for example, a magnetic disk, an optical disk, a read-only memory (“ROM”), or a random access memory (“RAM”), an Electrically Programmable read only memory (“EPROM”), an Electrically Erasable Programmable read only memory (“EEPROM”), a register, a hard disk, a solid-state disk drive, a smart media card (“SMC”), a secure digital card (“SD”), a flash card, etc. Furthermore, any computing systems described in the specification may include a single processor or may be architectures employing multiple processors for increased computing capability. The processor may be a central processing unit (“CPU”), a graphics processing unit (“GPU”), or any processing device configured to process data and/or performing computation based on data. The processor may include both software and hardware components. For example, the processor may include a hardware component, such as an application-specific integrated circuit (“ASIC”), a programmable logic device (“PLD”), or a combination thereof. The PLD may be a complex programmable logic device (“CPLD”), a field-programmable gate array (“FPGA”), etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A system, comprising:
a display panel;
an imaging assembly including a plurality of optical elements configured to guide a backlight to illuminate the display panel; and
a waveguide including a reflective polarizer and disposed between the plurality of optical elements included in the imaging assembly,
wherein the display panel is configured to modulate the backlight into an image light representing a virtual image,
wherein the imaging assembly is configured to guide the image light toward the reflective polarizer, and
wherein the reflective polarizer is configured to couple the image light into the waveguide.

2. The system of claim 1, further comprising:
an illumination assembly configured to emit the backlight, wherein the illumination assembly includes a light source array including a plurality of individually addressable illumination units, and wherein each illumination unit is configured to emit a first light beam having a first solid angle; and
a concentrator array coupled with the light source array and including a plurality of concentrators, wherein each concentrator is configured to condition the first light beam into a second light beam associated with a second solid angle that is smaller than the first solid angle, and wherein the second light beam is configured to provide a substantially uniform illumination at an exit aperture of the concentrator,
wherein the imaging assembly is configured to image the substantially uniform illumination at the exit aperture of the concentrator onto the display panel.

3. The system of claim 1, wherein the display panel and at least one of the plurality of optical elements included in the imaging assembly are disposed at two different sides of the waveguide.

4. The system of claim 1, wherein the reflective polarizer is embedded inside the waveguide at an input region of the waveguide.

5. The system of claim 1, wherein the imaging assembly includes:
a polarization beam splitter (“PBS”) disposed between the waveguide and the display panel;
a first lens assembly disposed at a first side of the PBS;
a first curved mirror disposed at a second side of the PBS opposite to the first side;
a second lens assembly disposed at a third side of the PBS, and between the PBS and the display panel; and
a second curved mirror disposed at a fourth side of the PBS opposite to the third side, wherein the waveguide is disposed between the second curved mirror and the PBS.

6. The system of claim 5,
wherein the first lens assembly, the PBS, the first curved mirror, and the second lens assembly are configured to guide the backlight to illuminate the display panel,
wherein the second lens assembly and the PBS are configured to direct the image light output from the display panel to propagate through the waveguide toward the second curved mirror,
wherein the second curved mirror is configured to reflect the image light transmitted through the waveguide back to the waveguide, and
wherein the reflective polarizer is configured to couple the image light into the waveguide.

7. The system of claim 1,
wherein the imaging assembly includes a first lens assembly and a second lens assembly,
wherein the second lens assembly is disposed between the waveguide and the display panel, and
wherein the waveguide is disposed between the first lens assembly and the second lens assembly.

8. The system of claim 7,
wherein the first lens assembly and the second lens assembly are configured to guide the backlight to propagate through the waveguide toward the display panel to illuminate the display panel,
wherein the display panel is configured to modulate the backlight into the image light propagating back to the waveguide, and
wherein the reflective polarizer is configured to couple the image light into the waveguide.

9. The system of claim 1,
wherein the imaging assembly includes a first lens assembly, a polarization recycling assembly, a reflector, and a second lens assembly,
wherein the polarization recycling assembly and the reflector are disposed at a first side of the waveguide, and the second lens assembly and the display panel are disposed at a second side of the waveguide opposite to the first side,
wherein the second lens assembly is disposed between the waveguide and the display panel, and
wherein the waveguide is disposed between the second lens assembly and the reflector.

10. The system of claim 9,
wherein the reflector and the display panel are disposed to face a first region of the waveguide where the reflective polarizer is disposed,
wherein the waveguide further includes an out-coupling element disposed at a second region of the waveguide, the out-coupling element being configured to couple the image light out of the waveguide, and
wherein the polarization recycling assembly is disposed at a third region of the waveguide, the first region being positioned between the second region and the third region.

11. The system of claim 9,
wherein the first lens assembly, the polarization recycling assembly, the reflector, and the second lens assembly are configured to guide the backlight to propagate through the waveguide toward the display panel to illuminate the display panel,
wherein the display panel is configured to modulate the backlight into the image light propagating back to the waveguide, and
wherein the reflective polarizer is configured to couple the image light into the waveguide.

12. The system of claim 9,
wherein the reflective polarizer included in the waveguide includes a first reflective polarizing layer, and the reflector included in the imaging assembly includes a first reflective layer,
wherein the polarization recycling assembly includes a second reflective polarizing layer, a substrate, a waveplate, and a second reflective layer,
wherein the second reflective polarizing layer is disposed at a first side of the substrate to face the waveguide,
wherein the waveplate and the second reflective layer are disposed at a second side of the substrate opposite to the first side, and
wherein the waveplate is disposed between the substrate and the second reflective layer.

13. The system of claim 12, wherein the substrate includes a first region that is covered by the second reflective polarizing layer and a second region that is not covered by the second reflective polarizing layer.

14. The system of claim 13,
wherein the backlight incident onto the second reflective polarizing layer is a first backlight including a first portion having a first polarization, and a second portion having a second polarization orthogonal to the first polarization,
wherein the second reflective polarizing layer is configured to reflect the first portion of the first backlight as a second backlight propagating toward the first reflective layer, and transmit the second portion of the first backlight as a third backlight propagating toward the first region of the substrate,
wherein the first region of the substrate is configured to transmit the third backlight toward a stack of the waveplate and the second reflective layer,
wherein the stack of the waveplate and the second reflective layer is configured to reflect the third backlight back to the second region of the substrate as a fourth backlight having the first polarization, and
wherein the second region of the substrate is configured to transmit the fourth backlight toward the first reflective layer.

15. The system of claim 1, further comprising:
an infrared light source disposed at or adjacent to a base surface of the waveguide,
wherein the infrared light source is configured to emit an infrared light propagating toward an out-coupling element of the waveguide.

16. The system of claim 1, further comprising:
an optical sensor disposed at or adjacent to a base surface of the waveguide,
wherein the optical sensor is configured to receive an infrared light deflected by an out-coupling element of the waveguide.

17. The system of claim 1, wherein the reflective polarizer included in the waveguide includes a first reflective polarizing layer configured to transmit a light having a first polarization and reflect a light having a second polariton orthogonal to the first polarization, wherein the system further comprises:
a stack of a waveplate and a second reflective polarizing layer disposed at a base surface of the waveguide; and
an infrared light source disposed adjacent to the stack of the waveplate and the second reflective polarizing layer.

18. The system of claim 17,
wherein the infrared light source is configured to emit a first infrared light propagating toward the first reflective polarizing layer,
wherein the first reflective polarizing layer is configured to reflect the first infrared light toward the stack of the waveplate and the second reflective polarizing layer,
wherein the stack of the waveplate and the second reflective polarizing layer is configured to reflect the first infrared light back to the first reflective polarizing layer as a second infrared light having the second polarization, and
wherein the first reflective polarizing layer is configured to transmit the second infrared light toward an out-coupling element of the waveguide.

19. The system of claim 1,
wherein the reflective polarizer included in the waveguide includes a first reflective polarizing layer configured to transmit a light having a first polarization and reflect a light having a second polariton orthogonal to the first polarization, and
wherein the system further comprises:
a stack of a waveplate and a second reflective polarizing layer disposed at or adjacent to a base surface of the waveguide; and
an optical sensor disposed adjacent to the stack of the waveplate and the second reflective polarizing layer.

20. The system of claim 19,
wherein an out-coupling element of the waveguide is configured to deflect a first infrared light toward the first reflective polarizing layer,
wherein the first reflective polarizing layer is configured to transmit the first infrared light toward the stack of the waveplate and the second reflective polarizing layer,
wherein the stack of the waveplate and the second reflective polarizing layer is configured to reflect the first infrared light back to the first reflective polarizing layer as a second infrared light having the second polarization, and
wherein the first reflective polarizing layer is configured to reflect the second infrared light toward the optical sensor.
